(19) United States
(12) Patent Application Publication
(10) Pub. No.: US 2025/0126492 A1
(43) Pub. Date: Apr. 17, 2025

(54) FLOATING SATELLITE GROUND STATION WITH ADAPTABLE FEEDER LINK

(71) Applicants: Stephen T. Palermo, Chandler, AZ (US); Patrick L. Connor, Beaverton, OR (US); Valerie J. Parker, Portland, OR (US)

(72) Inventors: Stephen T. Palermo, Chandler, AZ (US); Patrick L. Connor, Beaverton, OR (US); Valerie J. Parker, Portland, OR (US)

(21) Appl. No.: 18/988,599

(22) Filed: Dec. 19, 2024

Related U.S. Application Data
(60) Provisional application No. 63/669,536, filed on Jul. 10, 2024.

(51) Int. Cl. H04W 24/02; H04W 76/20; H04W 84/06

(52) U.S. Cl. CPC H04W 24/02; H04W 76/20; H04W 84/06

(57) ABSTRACT

Various approaches for configuring or operating a floating satellite network ground station on a ship or other marine vessel that transits among multiple geographic areas, are discussed. An example method for configuration includes: receiving configuration information for a compute node (e.g., mobile data center) to be operated as a temporary non-terrestrial network (NTN) ground station, with the compute node located on a marine vessel that has connectivity to the satellite NTN via a feeder link; configuring the compute node to operate as the temporary NTN ground station, based on the configuration information; and modifying the feeder link to perform data communications between the temporary NTN ground station and respective orbiting satellites of the satellite NTN. The feeder link is dynamically modified based on network usage and restrictions applicable to a geographic location of the marine vessel, such as an exclusion zone (EZ) defined for NTN communications.

### PRIORITY CLAIM

This application claims the benefit of priority to U.S. Provisional Patent Application No. 63/669,536, filed Jul. 10, 2024, and titled “FLOATING SATELLITE GROUND STATION WITH ADAPTABLE FEEDER LINKS”, which is incorporated herein by reference in its entirety.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 illustrates network connectivity in non-terrestrial (satellite) and terrestrial (e.g., mobile cellular network) settings, according to an example;

FIGS. 2A, 2B, and 2C depict maps showing non-terrestrial network coverage and connectivity among various geographic areas, according to an example;

FIGS. 3A and 3B depict various connection scenarios for coordinating multiple ground stations respectively located on a ship or other marine vessel/platform, according to an example.

FIG. 4 depicts a flowchart of operations for implementing a floating satellite ground station on a ship or other marine vessel/platform, according to an example;

FIG. 5 depicts an example coordination of a shore-based exclusion zone with operations of a floating satellite ground station on a ship or other marine vessel/platform, according to an example;

FIGS. 6A, 6B, 6C, 6D, 6E, 6F, and 6G depict additional details of an example architecture for supporting edge connections and data processing via a 5G network, deployed via a floating satellite ground station on a ship or other marine vessel/platform, according to an example;

FIG. 7 depicts a flowchart of operations for implementing a floating satellite ground station with an adaptable feeder link, according to an example;

FIGS. 8A, 8B, 8C, and 8D illustrate scenarios of geographic satellite connectivity from low-earth orbit satellite communication networks, according to an example;

FIGS. 9A, 9B, and 9C illustrate respective configurations of non-terrestrial and 5G network architectures, according to an example;

FIG. 10 illustrates an implementation of exclusion zones provided for transmissions from a non-terrestrial communication network, according to an example;

FIG. 11 illustrates various types of exclusion zones implemented for transmissions from a non-terrestrial communication network, according to an example;

FIG. 12 illustrates a flowchart of an example method of implementing exclusion zones for communications from a non-terrestrial communication network, according to an example;

FIGS. 13A and 13B illustrate examples of exclusion zones implemented for transmissions from a non-terrestrial communication network, according to an example;

FIGS. 14A and 14B illustrate further views of exclusion zones implemented for transmissions from a non-terrestrial communication network, according to an example;

FIG. 15A illustrates an overview of example components deployed at a compute node system, according to an example;

FIG. 15B illustrates a further overview of example components within a computing device, according to an example; and

FIG. 16 illustrates a software distribution platform to distribute software instructions and derivatives, according to an example.

### OVERVIEW

The following discussion relates to various aspects of non-terrestrial network (NTN) constellation operations, by using ephemeral floating ground stations with adaptable satellite feeder links. A respective ground station (GS) can support a large but often limited number of subscribers (e.g., in some networks, in a range of thousands of subscribers); therefore, the more GSs that are deployed, the more network capacity and revenue potential that becomes available for connectivity with the satellite network.

This disclosure introduces the use of water-transitable, moving/mobile NTN GS deployments on marine vessels, as well as the ability to adapt the allocation of Operations, Administration, and Maintenance (OAM), Control, and Data channels or paths within different feeder links to such ground stations, depending on circumstances for a particular GS. For example, more control data might be needed to synchronize the data to and from the satellite constellation in some scenarios (e.g., perhaps caused by environmental interference or multi-path communications). In other examples, data channels may need to be prioritized to enable delivery of time-sensitive content from one location to another. The balance of OAM, Control, and Data channels can dynamically expand and contract in the feeder link, using the techniques discussed herein.

As will be understood, a relevant technical problem is that Internet connectivity from user terminals (satellite terminals) to satellite constellations is limited by the availability of NTN GSs to transport data to-and-from Earth to the satellite constellations, since often GSs are used as a gateway to the Internet (or other portions of a TN/NTN). Each country typically has different GS bandwidth capabilities used to feed satellite constellations. Because the GS feeder link bandwidth varies from location to location, it is impractical or impossible to schedule all GS feeder links the same. As already noted, a GS feeder link needs to accommodate operation and maintenance data, user data, and control data. Thus, in many existing environments, a limited number of GS feeder links are manually scheduled between a GS and an NTN with no adaptability.

The following thus introduces aspects of a floating NTN GS, which provide adaptable GS feeder links to a satellite constellation. A floating NTN GS is hosted by a ship, barge, platform, or other marine vessel as a “floating” neutral host. In this way, the floating NTN GS on the ship or vessel is used in the same manner as an on-Earth GS to extend coverage and/or capacity of TN and/or NTN networks. The floating GS may also serve as a data host (e.g., to serve pre-cached data or content to multiple users), or itself be accompanied by requirements for data consumption and usage (e.g., when deployed on a cruise ship with thousands of passenger users who consume data).

This discussion of a floating NTN GS is followed by examples of a scheduling flow for configuring and operating feeder links between the floating NTN GS and a satellite constellation. Further adaptations include the use of a Ship-to-Shore Exclusion Zone, to prevent or mitigate interference with land-based networks, and Ship-based Integrated Access Backhaul, to serve as a backhaul to marine-or land-based stations and network users. The following discussion also introduces aspects of a “floating” edge-data center or compute node that can be co-located with Access and Backhaul (including, in further examples, the implementation of a data center capable of performing updates, AI safety applications, object detections, and other processing actions).

### Overview of Non-Terrestrial Network Configurations

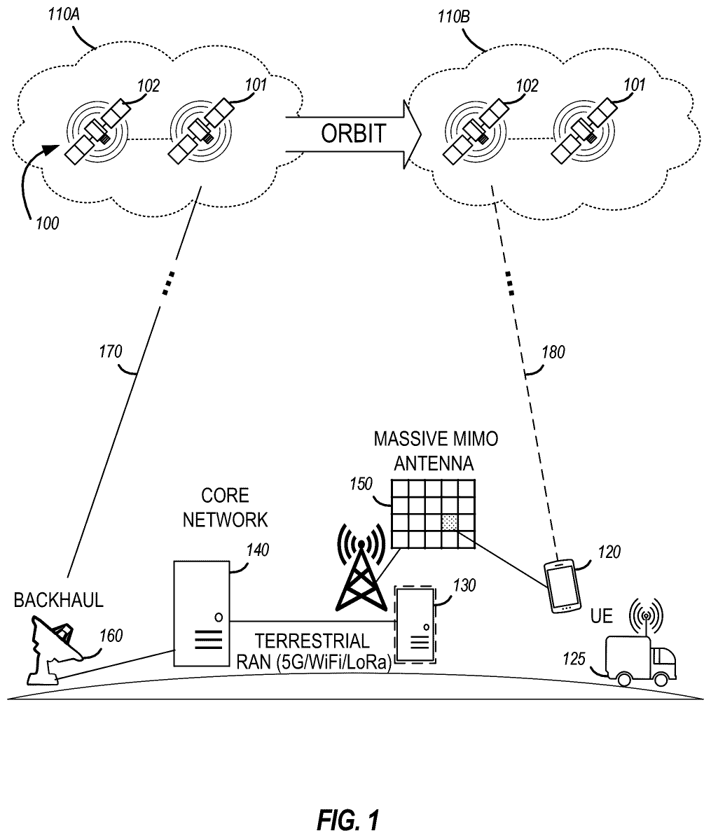

FIG. 1 illustrates network connectivity in non-terrestrial (satellite) and terrestrial (e.g., mobile cellular network) settings, according to an example. As shown, a satellite constellation 100 (the constellation depicted in FIG. 1 at orbital positions 110A and 110B) may include multiple satellite vehicles (SVs) 101, 102, which are connected to one or more other SVs and to one or more terrestrial networks. The individual satellites in the constellation 100 (e.g., SVs) conduct an orbit around the Earth, at an orbit speed that increases as the SV is closer to Earth. LEO constellations are generally considered to include SVs that orbit at an altitude between 160 and 1000 km; at this altitude, a SV typically orbits the Earth about every 90 to 120 minutes.

The constellation 100 includes individual SVs 101, 102 (and numerous other SVs not shown), and uses multiple SVs to provide communications coverage to a geographic area on Earth. The constellation 100 may also coordinate with other satellite constellations (not shown), and with terrestrial-based networks, to selectively provide connectivity and services for individual devices (user equipment) or terrestrial network systems (network equipment).

In this example, the satellite constellation 100 is connected via a satellite link 170 to a backhaul network 160, which is in turn connected to a 5G core network 140. The 5G core network 140 is used to support 5G communication operations with the satellite network and at a terrestrial 5G radio access network (RAN) 130. For instance, the 5G core network 140 may be located in a remote location and use the satellite constellation 100 as the exclusive mechanism to reach wide area networks and the Internet. In other scenarios, the 5G core network 140 may use the satellite constellation 100 as a redundant link to access the wide area networks and the Internet; in still other scenarios, the 5G core network 140 may use the satellite constellation 100 as an alternate path to access the wide area networks and the Internet (e.g., to communicate with networks on other continents).

FIG. 1 additionally depicts the use of the terrestrial 5G RAN 130, to provide radio connectivity to a user equipment (UE) such as user device 120 or vehicle 125 on-ground via a massive MIMO antenna 150. It will be understood that a variety of 5G and other network communication components and units are not depicted in FIG. 1 for purposes of simplicity. In some examples, the UE 120 or 125 also may have its own satellite connectivity hardware (e.g., receiver circuitry and antenna), to directly connect with the satellite constellation 100 via satellite link 180. Although a 5G network setting is depicted and discussed at length in the following sections, it will be apparent that other variations of 3GPP, O-RAN, and other network specifications may also be applicable.

Other permutations (not shown) may involve a direct connection of the 5G RAN 130 to the satellite constellation 100 (e.g., with the 5G core network 140 accessible over a satellite link); coordination with other wired (e.g., fiber), laser or optical, and wireless links and backhaul; multi-access radios among the UE, the RAN, and other UEs; and other permutations of terrestrial and non-terrestrial connectivity. Satellite network connections may be coordinated with 5G network equipment and user equipment based on satellite orbit coverage, available network services and equipment, cost and security, and geographic or geopolitical considerations, and the like. With these basic entities in mind, and with the changing compositions of mobile users and in-orbit satellites, the following techniques describe ways in which terrestrial and satellite networks can be extended for various edge computing scenarios.

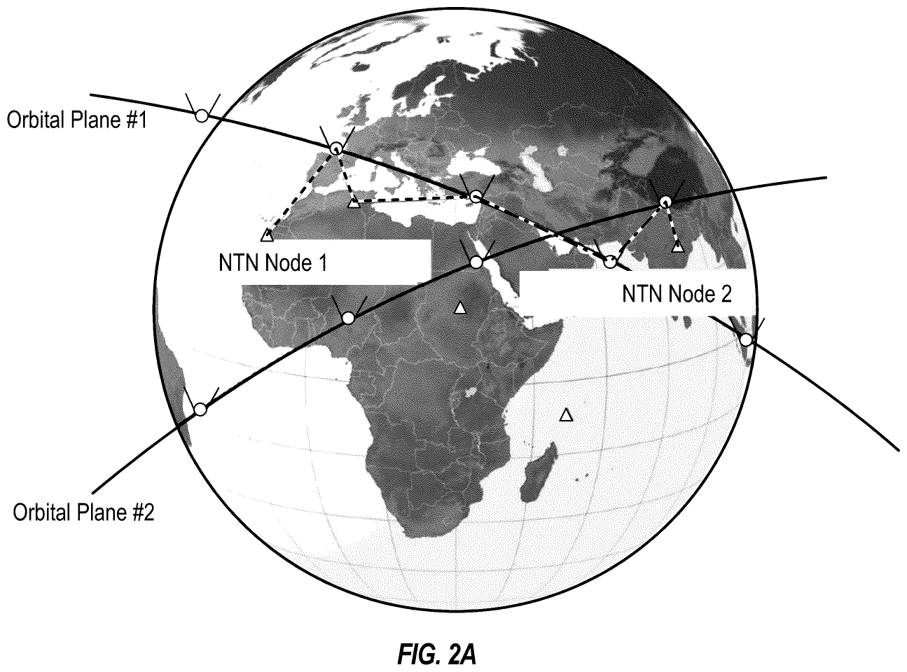

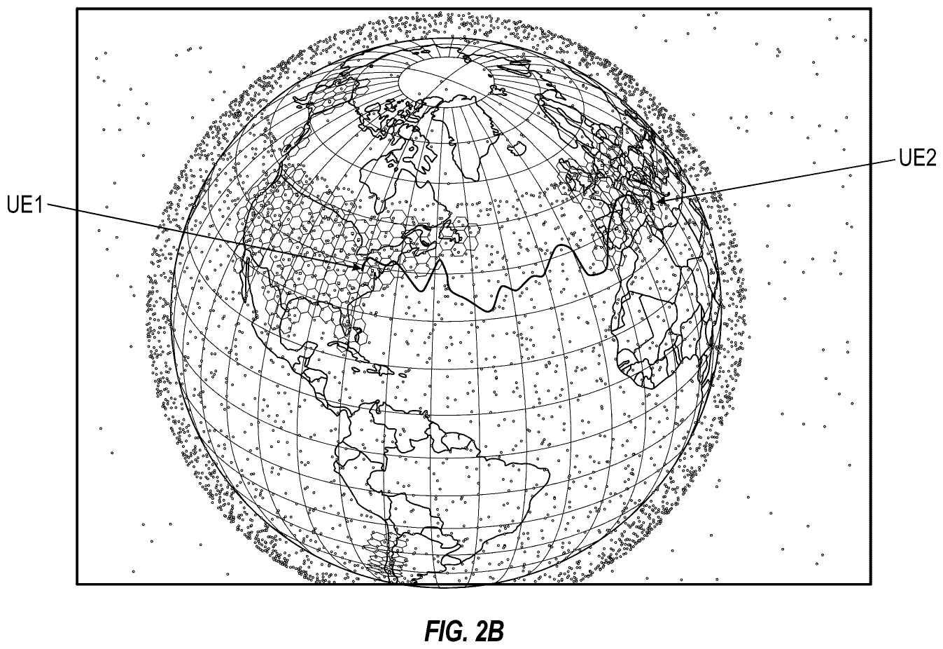

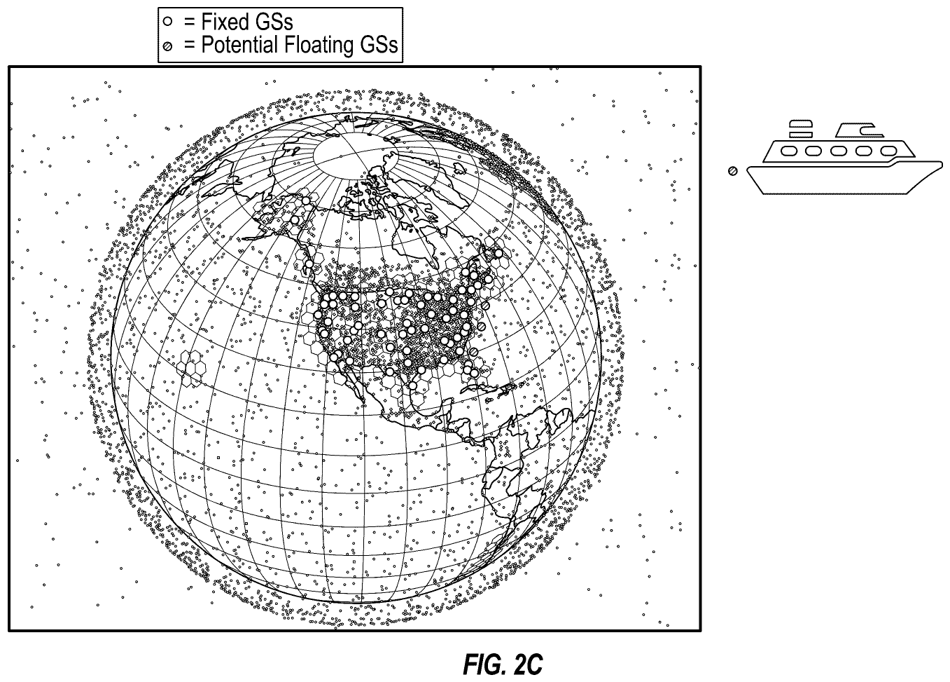

FIG. 2A depicts a geographical map showing how an NTN network or networks may include multiple constellations and orbital planes that provide service to multiple geographic areas. Accordingly, a variety of interference concerns may be raised as from ground coverage among many different countries, as space-originating broadcasts are provided from different constellations (and, potentially different service providers) from constellations.

FIG. 2B depicts a connection scenario involving connectivity from a first UE (UE 1) to a second UE (UE 2) via a complex pathway of non-terrestrial network connections. For instance, the first UE is located on a first continent, and connects to a first SV of a first satellite constellation. The second UE is located on a second continent, and connects to a second SV of a second satellite constellation. Establishing connectivity between the first UE and the second UE implicates a number of connections, whether in-space (with inter-satellite links among SVs), to and from the SVs, and via ground stations used for coverage and connectivity with the UEs and the NTN.

FIG. 2C depicts another illustration of geographic connectivity for an example NTN network, showing how ground stations are dispersed across the North America continent for coverage and connectivity with the satellite network. Here, coverage for highly-populated areas adjacent to land may be greatly enhanced with the use of “floating” ground stations that are operated on boats, off-shore platforms, cruise ships, barges, or other types of marine vessels and marine stations.

### Floating Marine Vessel NTN Ground Station Configurations

The following introduces system configurations that enable a marine vessel (e.g., cruise ship) to serve as a floating or mobile GS to augment contention in an active satellite constellation (e.g., Low-Earth Orbit constellations such as Starlink® or Iridium®). These floating GSs can be activated on-demand, based on observed or expected network utilization. For example, if nearby terrestrial ground stations are below a predetermined utilization limit (e.g., 50%) then the ship (floating) GS is not enabled for NTN GS processing. On the other hand, if the ship (floating) GS is deemed useful to provide additional processing or bandwidth capabilities for the NTN (e.g., the nearby ground station utilization is at or expected to reach 90%), then a feeder link is activated to the ship (floating) GS and managed to provide additional network processing capability.

As used herein, a feeder link refers to the definition of a feeder link provided in Article 1.115 of the International Telecommunication Union (ITU) Radio Regulations. This defines a feeder link as a radio link from an earth station at a given location to a space station, or vice versa, conveying information for a space radiocommunication service other than for the fixed-satellite service. The given location may be at a specified fixed point, or at any fixed point within specified areas. Thus, even an LEO network that has orbiting satellites can constitute a fixed-satellite service because it can provide a radiocommunication service to fixed points on Earth.

The mechanism to add a marine vessel (floating) GS is similar to adding or deploying a new terrestrial (on-shore, fixed) ground station. However, an important capability with the use of the marine vessel (floating) GS is the ability to adjust the total available bandwidth allocated to User Plane, Control Plane, and Operation and Maintenance (OAM) Traffic. The total available bandwidth of the ship (floating) NTN link does not change, so the User/Control/OAM is constrained to that limit. However, the allocations among the User/Control/OAM portions may be different within that constrained limit (e.g., 20%/70%/10%). In an example, the mechanism to adjust a ratio among User/Control/OAM allocations depends on UL and DL Block Error Rate (BLER)/cyclic redundancy check (CRC) results of data sent to and from the ship (floating) GS. For example, if the UL BLER is 8%, then a higher User Plane traffic amount can be allocated (40%/30%/30%).

The deployment of a marine vessel (floating) GS can also account for ship-to-shore communication restrictions or other aspects of communication exclusion zones (EZs). When docked at a port, the floating GS may be connected via a wired connection (e.g., a fiber connection). When at sea, the floating GS may be connected via a wireless connection to another terrestrial location (e.g., with a microwave backhaul, with use of an Integrated Access Backhaul to a 5G network), or via an NTN connection to another network. The particular type or configuration of the wireless connection may be adapted based on the communication EZs (e.g., zones defined for on-shore areas that prohibit or limit wireless communications to prevent interference with other communication systems).

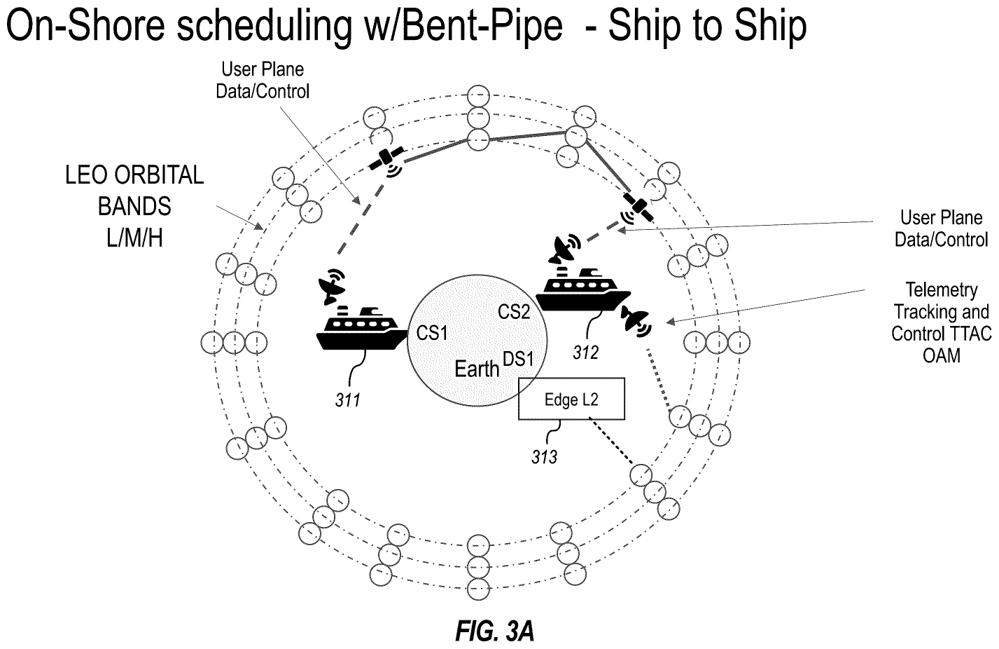

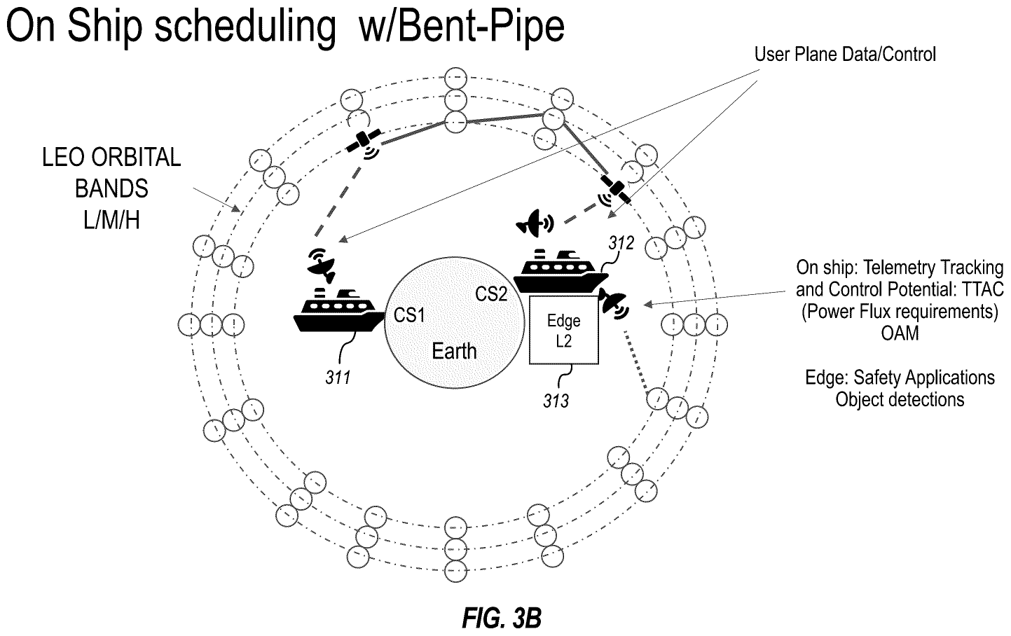

Variations of marine vessel (floating) GS connectivity scenarios are shown in more detail in FIGS. 3A and 3B. FIG. 3A depicts a connection scenario for coordinating multiple ground stations on mobile vessels (e.g., cruise ships, barges, etc.) located at separate areas on Earth. Here, a first ground station is located at Cruise Ship 1 (CS1 311), which establishes a user plane data/control path via a LEO network to Cruise Ship 2 (CS2 312). The CS2 312 can receive/provide telemetry tracking and control (TTAC) and OAM data via the LEO constellation. The CS2 312 may be communicatively coupled to a data center (DS1 313), which provides edge computing services. As will be understood, data consumers of DS1 313 and the edge computing services may be located on CS1 311 or CS2 312.

FIG. 3B depicts a further connection scenario for coordinating multiple ground stations on ships (e.g., cruise ships) located at separate areas on Earth. Like the scenario of FIG. 3A, a user plane data/control path is established between CS1 311 and CS2 312 via the LEO NTN constellation. However, in this scenario, the data center 313 that provides edge computing services is located on the ship CS2 312. The use of a data center enables on-ship generation of the TTAC and OAM information (including, in some examples, power flux requirements) to be provided from the ship CS2 312 to the NTN network. The edge computing services may also perform a variety of other operations such as to host safety applications, perform object detection, etc.

The feeder link between the floating (ship) GS and the satellite NTN can be adapted to accommodate different GS bandwidth capabilities. As noted, the amount of feeder link bandwidth can be allocated among control plane, user plane, and OAM—depending on need—as controlled by operator pre-sets and/or AI-determined adjustments. This adjustment may be needed because there can be different feeder link bandwidth capabilities depending on the location/country, and different needs for the use of that bandwidth at any particular time (e.g., due to changes in backhaul, bad signals that need additional synchronization, security restrictions, data demands, etc.).

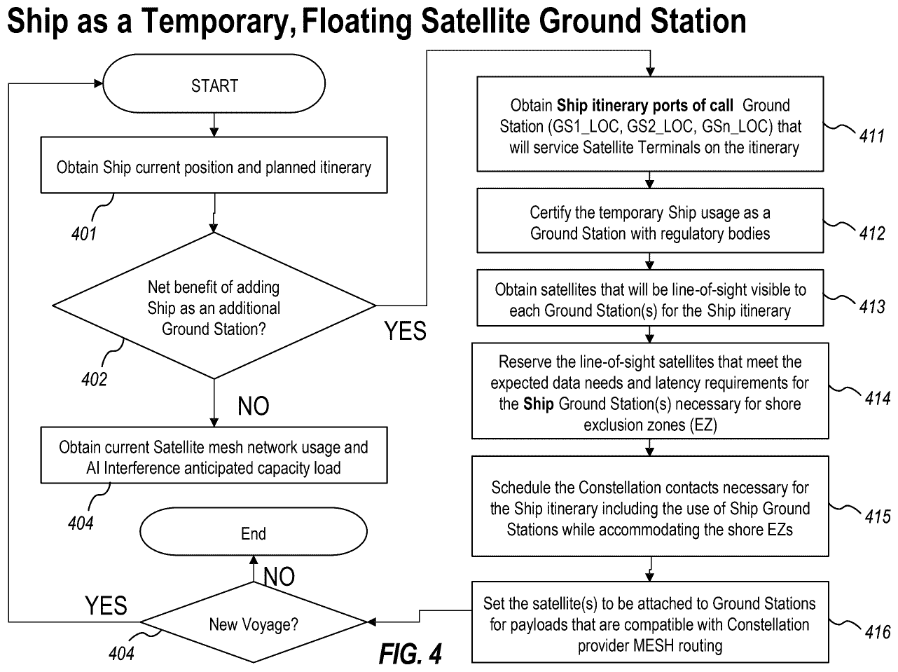

FIG. 4 depicts a flowchart of a method for implementing a temporary, floating satellite ground station with a data center located on a ship or other marine vessel/platform. Here, this method shows how a ship's current position and planned itinerary are obtained (operation 401) and evaluated before considering its use as an NTN GS. If there is a net benefit of adding the ship as an additional NTN GS (decision 402), the ship itinerary ports of call are obtained (operation 411) and used to identify ground station locations that will service satellite terminals (e.g., user terminals and backhaul connections) on the itinerary. If there is not a net benefit of adding the ship as an additional NTN GS (decision 402), then the current NTN mesh network usage and anticipated capacity load (e.g., expected via AI estimations) are obtained (operation 403) and evaluated.

If the ship is to be added as an additional, temporary NTN GS, then various aspects of configuration may be provided for the temporary NTN GS. This may include: certifying or verifying the ship with one or more regulatory bodies for temporary usage as an NTN GS (operation 412); obtaining information on the satellites that will be in line-of-sight to a GS for the itinerary of the ship (operation 413); reserving data with the satellites that will be line-of-sight, based on expected data needs and latency requirements (operation 414); scheduling constellation contacts for the ship itinerary, including use of the temporary NTN GS while also accommodating a shore exclusion zone and any other communication restrictions (operation 415); instructing the satellites to be attached to the temporary NTN GS, for payloads that are compatible with processing by the NTN GS. Upon changed conditions or the conclusion of the ship voyage (e.g., a new voyage), then a re-configuration may be performed (based on decision 404).

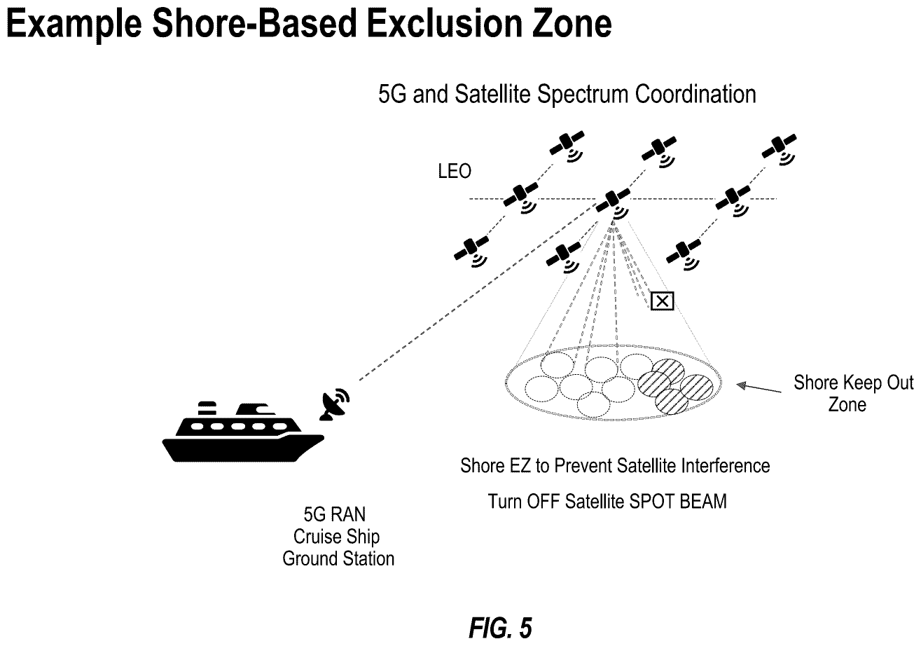

Accordingly, to enable use of a ship as an NTN GS, a variety of NTN and satellite information will be evaluated so that satellite capacity will be scheduled, reserved, and coordinated in connection with routing. Additional scheduling and coordination with multiple types of exclusion zones may be provided. An example scenario of an on-shore exclusion zone with coordination of a 5G RAN ship (floating) ground station is depicted in FIG. 5 and discussed below.

The feeder link used to connect an NTN with a proposed NTN GS on a ship is adaptable to the demand of a co-located data center (e.g., on the ship), even as the ship and the NTN GS use varying amounts of the available bandwidth. The bandwidth of respective channels or segments of the feeder link (segmented between USER_DATA, CONTROL, and OAM segments) may be adjusted based on near-real-time feedback. This feedback may include channel state information (CSI) and error measurements as noted above. Accordingly, the bandwidth of the feeder link between the NTN and the NTN GS may be adjusted-without exceeding the total available bandwidth of the link-in real-time while the floating NTN GS has line-of-sight with the SV.

In some examples, the feeder link connection may be based on a use of separate antennas on the SV to handle different bandwidth and usage scenarios. For example, some SVs of an NTN may include primary antennas (e.g., for ISL or for service links) within the constellation whereas other SVs include secondary antennas (e.g., used for feeder links). The scheduling of such SVs that include secondary antennas can be handled with MPS techniques, and which can also be subjected to exclusion zone coordination and scheduling. In further examples, the secondary antennas and an associated feeder link can use different FDD frequencies for upload/download (or, may use TDD based communications).

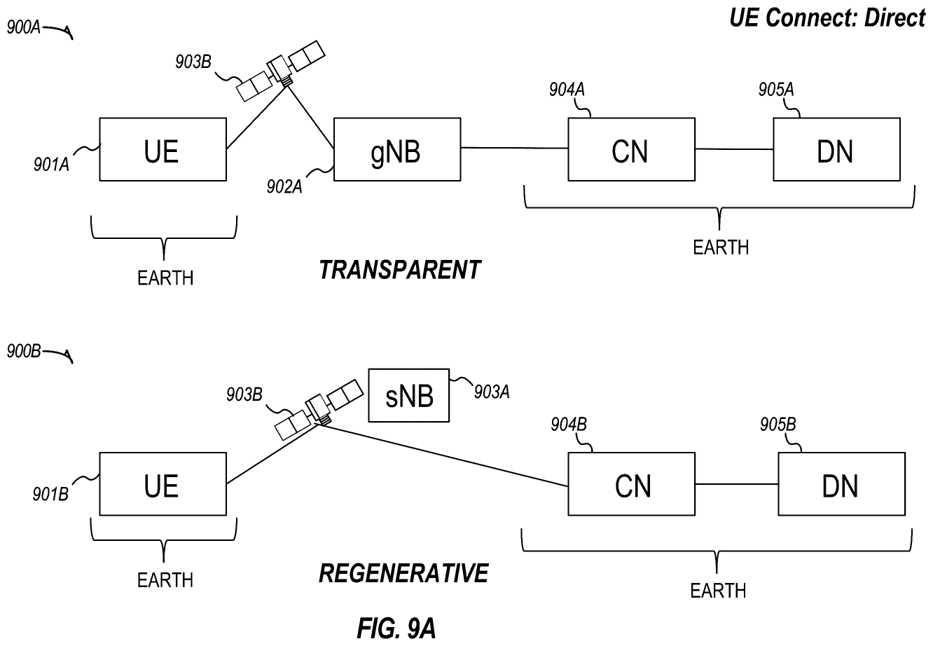

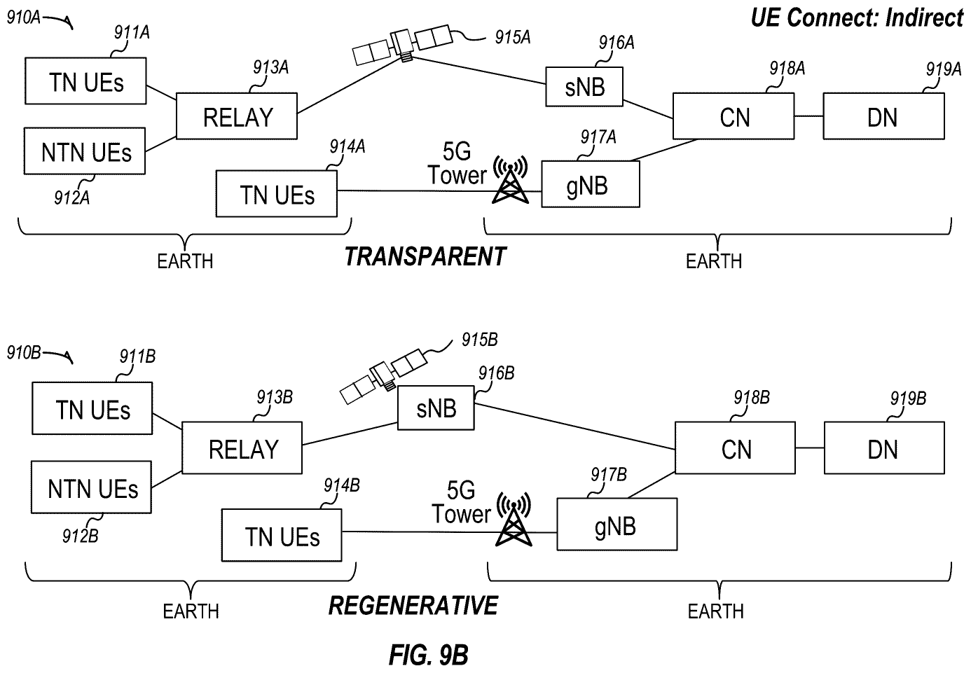

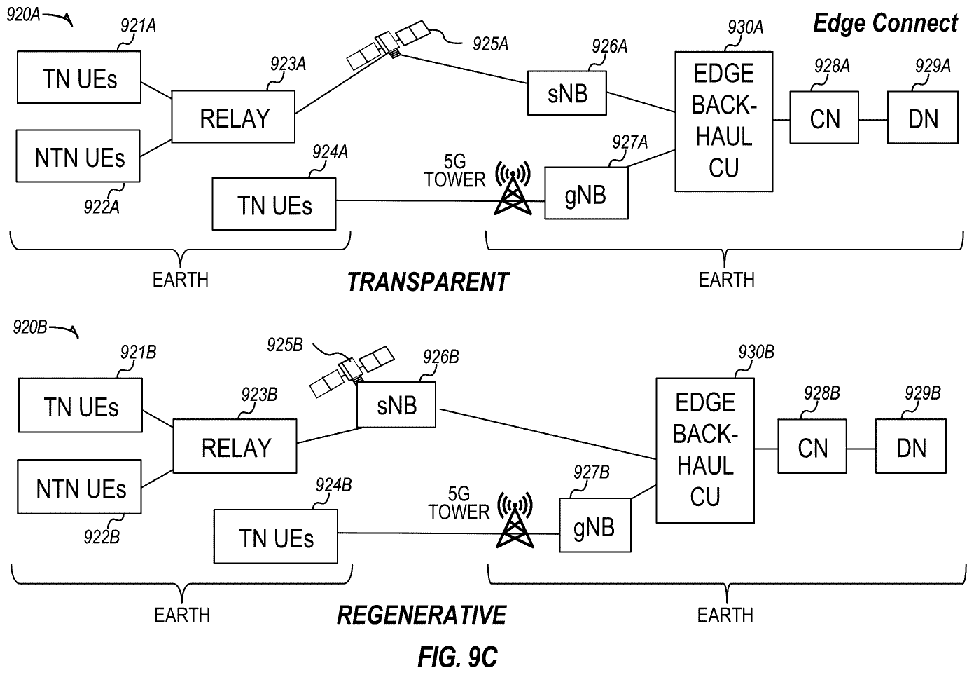

The deployment of a marine vessel NTN GS may enable provisioning of temporary Ground/Earth Station capacity in the localized NTN cell for a variety of transparent or re-generative NTN connection settings. Additional detail on configurations of transparent and re-generative NTN connections and networks is provided among FIGS. 9A to 9C. Accordingly, overall network and processing capacity can be increased with the use of an “extra” floating-GS, and enabled via a feeder link, that is operated at a co-located next to a datacenter and is only used when needed (on-demand).

FIG. 5 depicts an example use of a shore-based exclusion zone, to prevent satellite interference with on-ground communication equipment (e.g., 5G base stations). The definition of a shore-based exclusion zone may allow particular frequency bands, power levels, spot beams, or particular satellite communications to be changed or turned off, to remove or reduce interference in a shore keep-out zone. This exclusion zone may be dynamically moved based on the location and position (actual or scheduled location and position) of a ship such as a cruise ship.

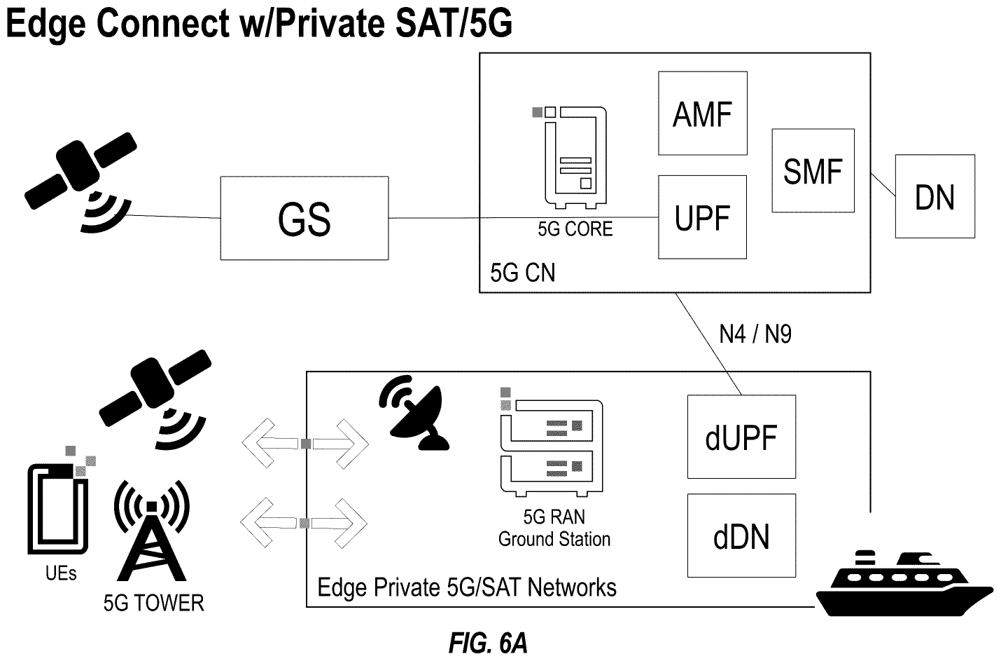

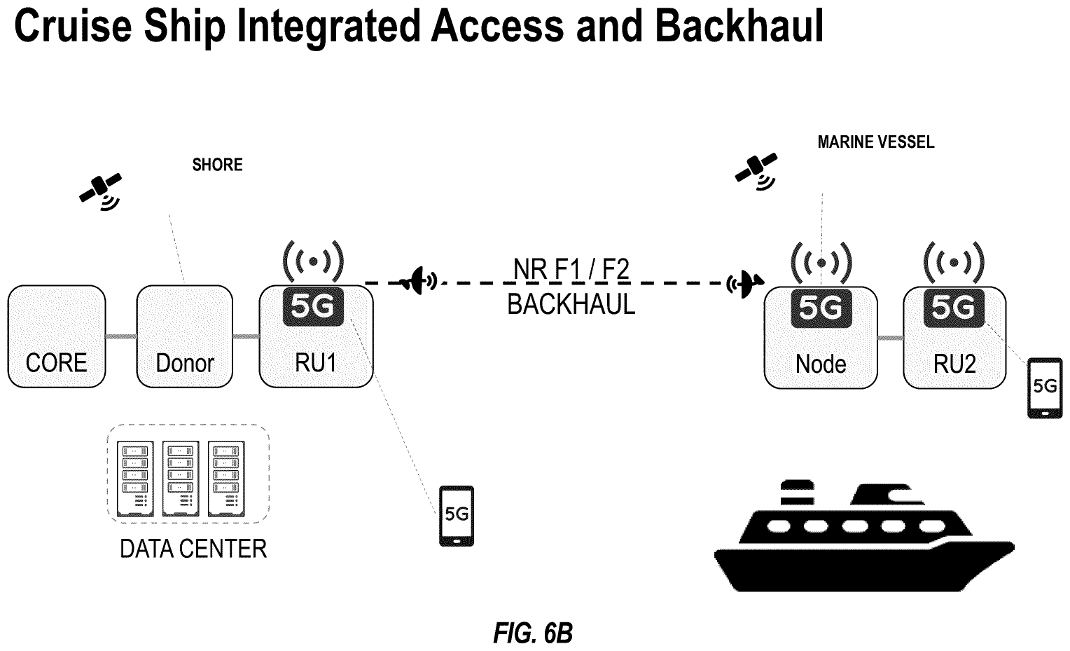

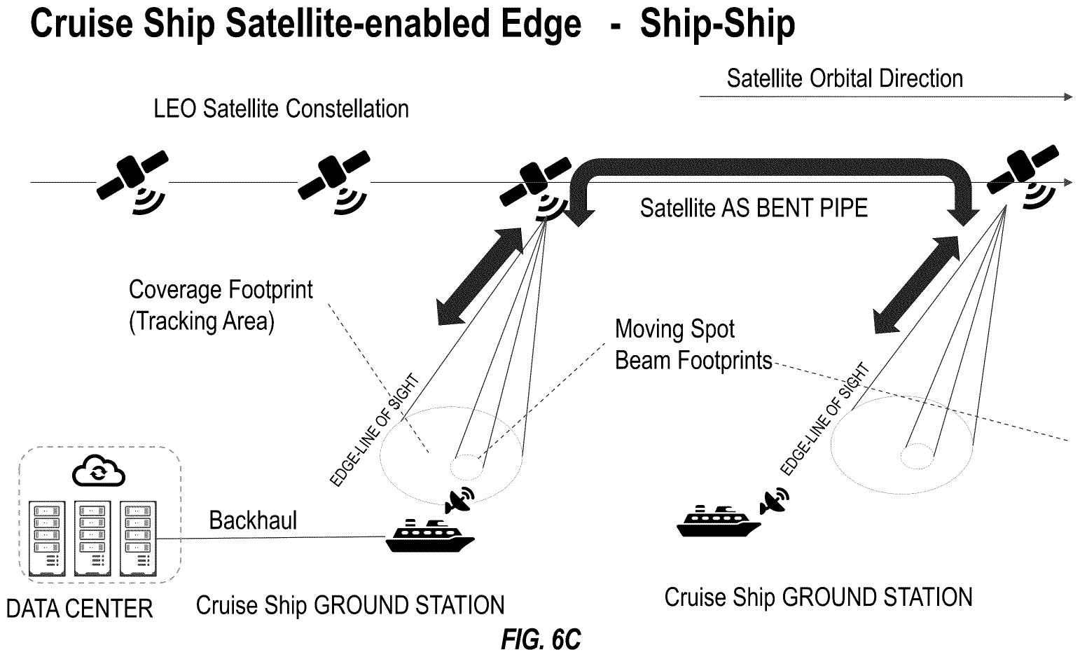

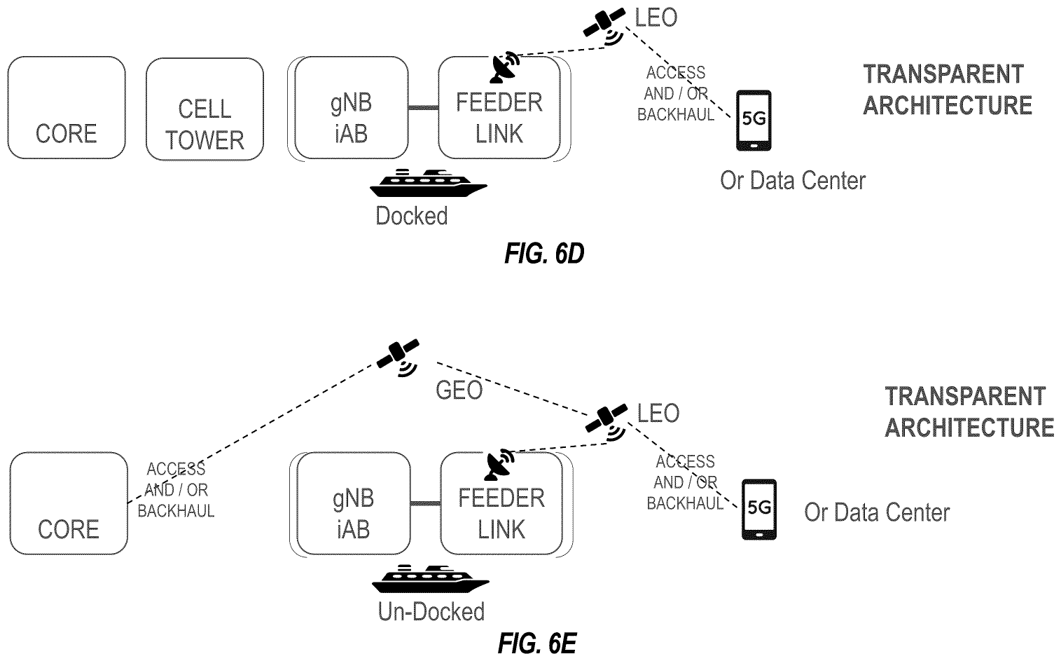

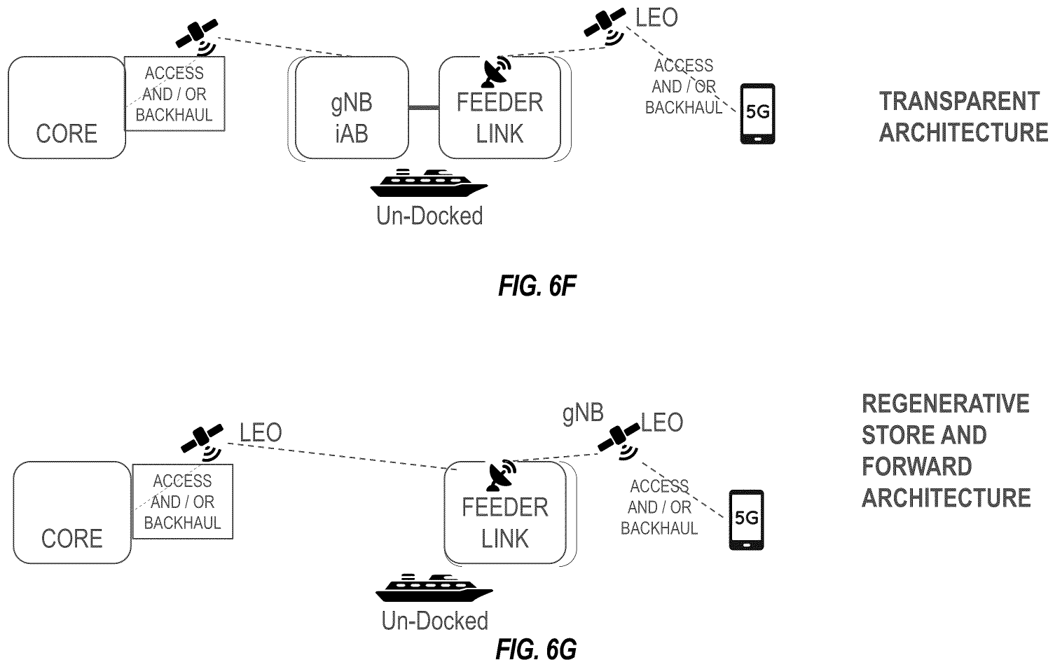

FIG. 6A depicts additional details of an example architecture for supporting edge connections and data processing via a 5G network. Here, the GS (e.g., located on a ship or other marine vessel or station) provides a backhaul to a 5G CN to perform processing. The 5G CN may include a backhaul to one or more other private 5G/satellite networks that offer connectivity.

FIGS. 6B and 6C provide further examples of how a ship or other marine vessel or station in motion, such as a cruise ship, can offer 5G services and connectivity. FIG. 6B first shows how an IAB scenario may be used to connect a 5G node and radio unit on a ship with a data center and 5G network core located on-shore. FIG. 6C also shows how a satellite network may be used to establish connectivity between ground stations and data centers. FIGS. 6D, 6E 6F, and 6G also show how backhaul may be accomplished for a 5G network in cases where a marine vessel is docked or undocked.

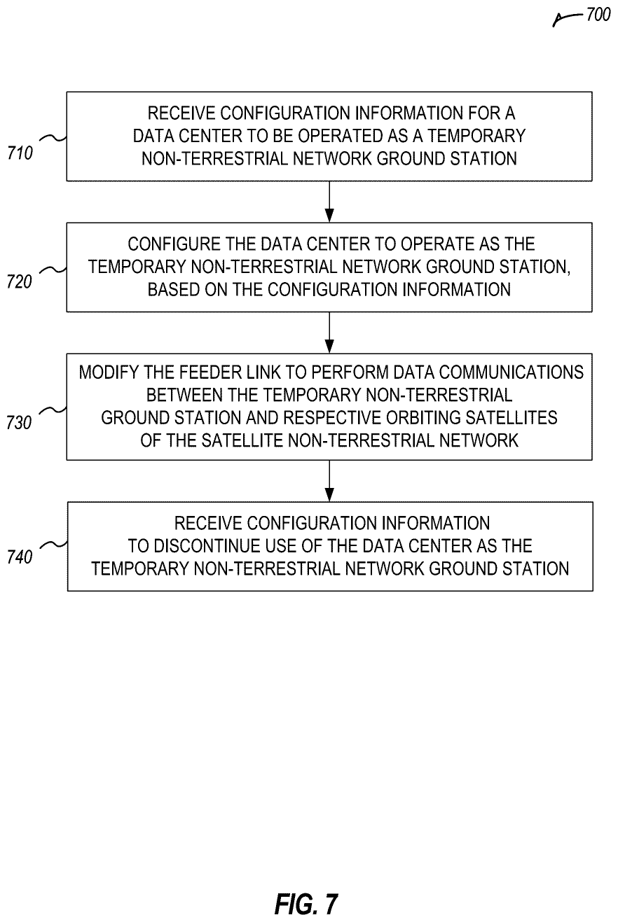

FIG. 7 depicts a flowchart of example operations for implementing a floating satellite ground station with adaptable feeder links. These operations may be adapted based on the other examples described herein, including other use cases for operation of an edge data center (compute node) for NTN and TN data processing.

At 710, operations are performed to receive configuration information for a data center located on a marine vessel to be operated as a temporary NTN ground station. As described herein, the data center on the marine vessel is capable of transiting among multiple marine locations, including in port and at sea locations. The marine vessel and the data center have connectivity to the satellite NTN via a feeder link, as discussed above.

At 720, operations are performed to configure the data center to operate as the temporary NTN ground station, based on the configuration information. This configuration causes the temporary NTN ground station to process data from satellite terminals of the satellite NTN (e.g., in a gateway, routing, server, or other network processing role). In an example, the data center is selected to be operated as a temporary NTN ground station based on utilization metrics of one or more other NTN ground stations (e.g., to provide additional capacity).

At 730, operations are performed to modify the feeder link to perform data communications between the temporary NTN ground station and respective orbiting satellites of the satellite NTN. Here, the feeder link is dynamically modified (e.g., in real-time) based on network usage and restrictions applicable to a geographic location (e.g., current location or planned location) of the marine vessel. In an example, the feeder link has a fixed bandwidth, and the real-time allocation of data includes respective allocations among: user plane data, control plane data, and Operations, Administration, and Maintenance (OAM) data. The respective allocations may be adjusted based on operational conditions of the satellite NTN and data usage (e.g., data usage occurring with one or more data networks hosted by the marine vessel, such as with a local 5G network). Additionally, the respective allocations may be adjusted based on one or more connection health metrics provided from among: upload block error rate, download block error rate or cyclic redundancy check (CRC) results.

At 740, operations are performed to receive configuration information (e.g., updated information) to discontinue use of the data center as the temporary NTN ground station. This configuration may be based on a decrease in the utilization metrics of the one or more other NTN ground stations, such as in a scenario where the temporary NTN ground station does not need to be deployed for NTN service operations.

In some examples, the data center is operated as the temporary NTN ground station when the marine vessel is undocked in a port geographic area. When undocked (e.g., at sea), the temporary NTN ground station can serve as a network gateway based on a wireless backhaul to an onshore network. In other examples, the data center is operated as the temporary NTN ground station when the marine vessel is docked in the port geographic area. When docked (e.g., in port), the temporary NTN ground station serves as the network gateway based on a wired backhaul when the marine vessel is docked.

As discussed in more detail in this document, the restrictions applicable to the geographic location of the marine vessel can include communication restrictions based on an exclusion zone. For example, an exclusion zone may define one or more geographical areas of restricted wireless communications for the feeder link between the satellite NTN and the marine vessel. Additionally, the exclusion zone may define or require one or more mitigations for use for transmissions from the satellite NTN, such as mitigations provided from among: spot beam control, frequency change, or beamsteering.

### Edge Computing and Processing via Satellite-Enabled Networks

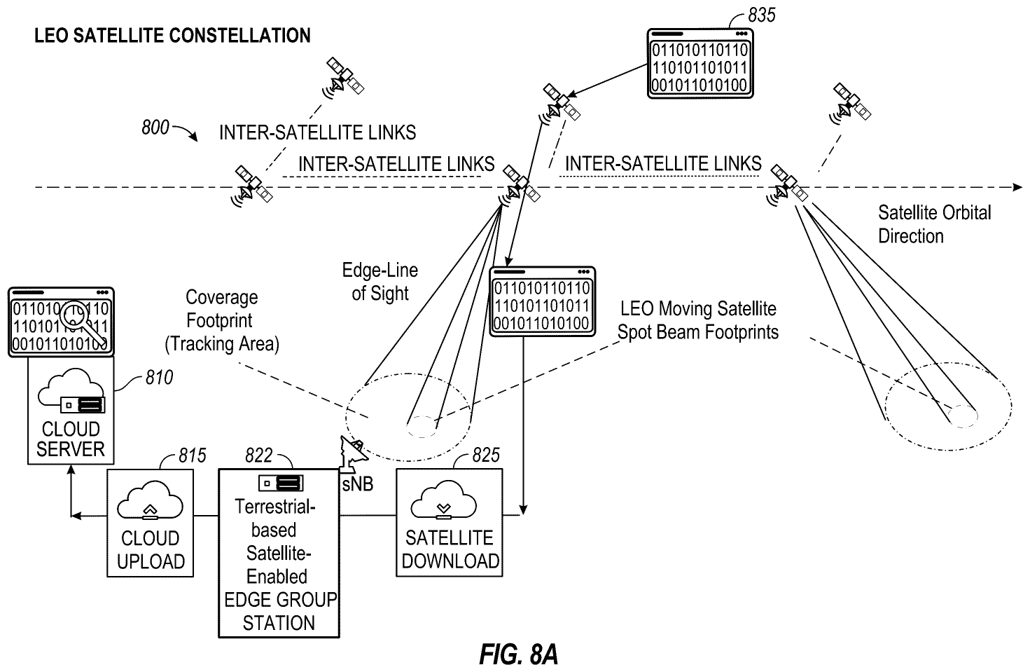

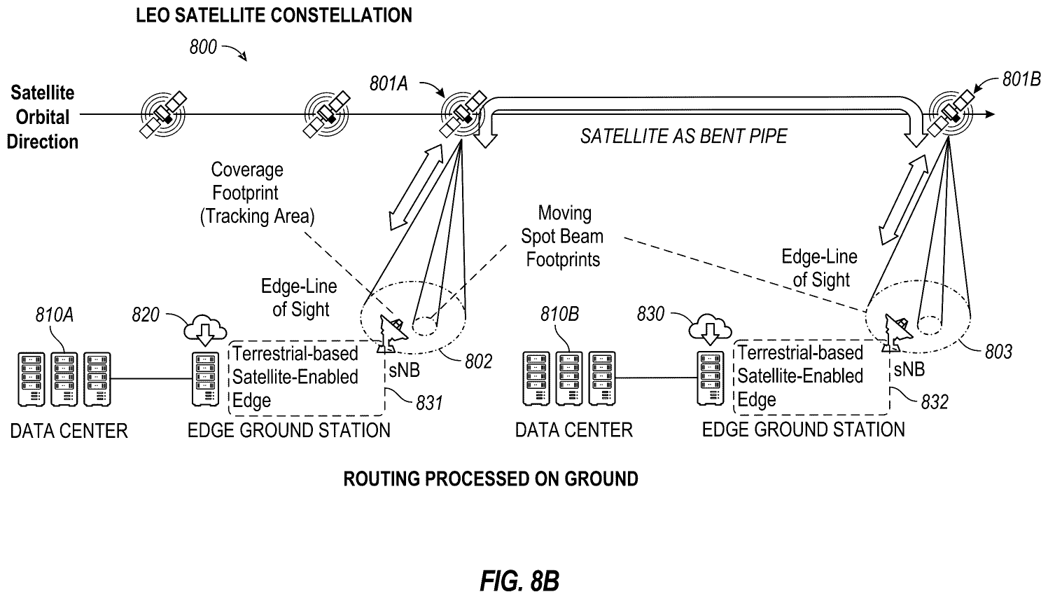

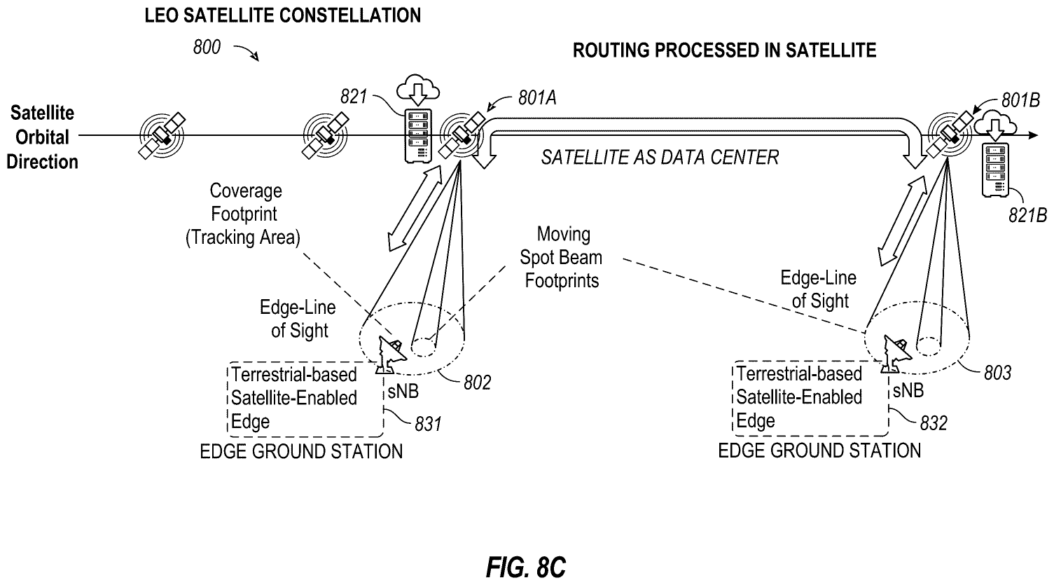

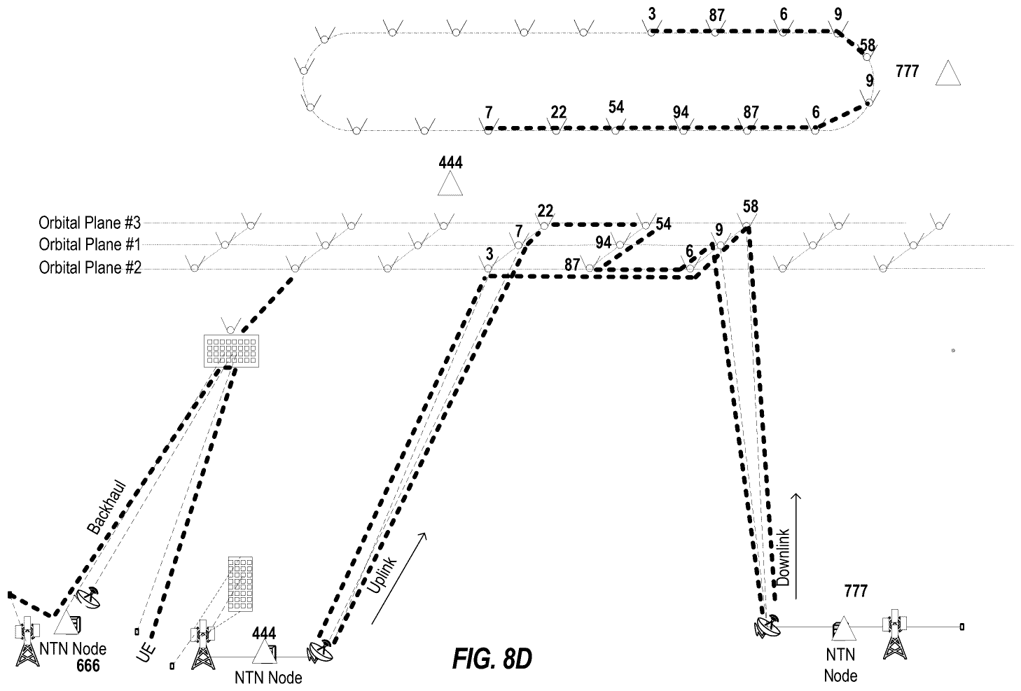

FIG. 8A illustrates an overview of terrestrial-based, satellite-enabled edge processing. As shown, a terrestrial-based, satellite-enabled edge ground station (satellite nodeB, sNB) 822 obtains coverage from a satellite constellation 800, and downloads a data set 835. The constellation 800 may coordinate operations to handoff the download using inter-satellite links (such as in a scenario where the data set 832 is streamed, or cannot be fully downloaded before the satellite footprint moves).

The satellite download 825 is provided to the sNB 820 for processing, such as with a cloud upload 815 to a server 810 (e.g., a CDN located at or near the sNB 820). Accordingly, once downloaded to the sNB 820 (and uploaded to the server 810), the user devices located within the terrestrial coverage area (e.g., 5G coverage area) of the sNB 820 now may access the data from the server 810.

FIG. 8B illustrates a terrestrial-based, satellite-enabled edge processing arrangement, where routing is performed “on-ground” and the satellite is used as a “bent pipe” between edge processing locations. Here, the term “bent pipe” refers to the use of a satellite or satellite constellation as a connection relay, to simply communicate data from one terrestrial location to another terrestrial location. As shown in this figure, a satellite constellation 800 has an orbital path, with a respective satellite moving from position 801A to 801B, providing separate coverage areas 802 and 803 for connectivity at respective times.

Here, when a satellite-enabled edge computing node 831 (sNB) is in the coverage area 802, it obtains connectivity via the satellite 800 (at position 801A), to communicate with a wider area network. Additionally, this edge computing node sNB 831 may be located at an edge ground station 820 which is also in further communication with a data center 810A, for performing computing operations at a terrestrial location.

Likewise, when a satellite-enabled edge computing node 832 (sNB) is in the coverage area 803, it obtains connectivity via the satellite 800 (at position 801B), to communicate with a wider area network. Again, computing operations (e.g., services, applications, etc.) are processed at a terrestrial location such as edge ground station 830 and data center 810B.

FIG. 8C illustrates another terrestrial-based, satellite-enabled edge processing arrangement. Similar to the arrangement depicted in FIG. 8B, this shows the satellite constellation 800 in a constellation along an orbital path, with a respective satellite moving from position 801A to 801B, providing separate coverage areas 802 and 803 at respective times. However, in this example, the satellite is used as a data center, to perform edge computing operations (e.g., serve data, compute data, relay data, etc.).

Specifically, at the satellite vehicle, edge computing hardware 821 is located to process computing or data requests received from the ground station sNBs 831, 832 in the coverage areas 802, 803. This may have the benefit of removing the communication latency involved with another location at the wide area network. However, due to processing and storage constraints, the amount of computation power may be limited at the satellite 800 and thus some requests or operations may be moved to the ground stations 831, 832.

As will be understood, edge computing and edge network connectivity may include various aspects of radio access network (RAN) and software defined networking processing. Specifically, in many of these scenarios, wireless termination may be moved between ground and satellite, depending on available processing resources. Further, in these scenarios, URLLC (ultra-reliable low latency connections) processing may be enabled, based on the configuration of inter-satellite communication links. These functionalities may be coordinated with the use of floating GSs as discussed herein.

FIG. 8D provides a further illustration of how an NTN can enable uplink and downlink among various NTN Nodes. This example shows how an NTN Node contact initiating at GS444 with line of sight to SV3 using GS777 resources then back to GS444 using optical ISLs, while some SVs are still in line-of-sight. However, in some scenarios, it may be faster to use SV down to terrestrial GS/relays than back up. In other words, a ground relay path may be faster than optical ISL SVs.

FIGS. 9A, 9B, and 9C illustrate respective configurations of non-terrestrial and 5G network architectures, which may be used with the configurations and mitigation techniques discussed herein. These include:

Direct Connection (with a transparent or “bent pipe” satellite arrangement):

Scenario 900A in FIG. 9A, e.g., Direct connect: UE 901A [symbol] [SATELLITE]903B [symbol] gNB 902A [symbol] CN 904A [symbol] DN 905A;

Scenario 910A in FIG. 9B, e.g., Multi-RAT, Multi Connectivity provided by transparent NTN-based NG-RAN and Cellular NG-RAN: UEs 911A or 912A [symbol] Relay 913A [symbol] [SATELLITE]915A [symbol] gNB 916A [symbol] CN 918A⇔DN 919A (in this scenario 910A, TN UEs 914A can directly connect to a gNB 917A and the CN 918A, DN 919A).

Scenario 920A in FIG. 9C, e.g., Multi-RAT, Multi Connectivity provided by transparent NTN-based NG-RAN and Cellular NG-RAN: UEs 921A or 922A [symbol] Relay 923A [symbol] [SATELLITE]925A [symbol] sNB 926A [symbol] Edge back-haul centralized unit (CU) 930A [symbol] CN 928A [symbol] DN 929A (in this scenario 910A, TN UEs 924A can directly connect to a gNB 927A and the CN 928A, DN 929A via the Edge back-haul CU 930A).

Direct Connection (with a regenerative satellite with gNB arrangement):

Scenario 900B in FIG. 9A: UE 901B [symbol] sNB 903A [at SATELLITE 903B] [symbol] CN 904B [symbol] DN 905B;

Scenario 910B in FIG. 9B, e.g., Multi-RAT, Multi Connectivity provided by transparent NTN-based NG-RAN and Cellular NG-RAN: UEs 911B or 912B [symbol] Relay 913B [symbol] sNB 916B [at SATELLITE 915B] [symbol] CN 918B [symbol] DN 919B (in this scenario 910B, TN UEs 914B can directly connect to a gNB 917B and the CN 918B, DN 919B).

Scenario 920B in FIG. 9C, e.g., Multi-RAT, Multi Connectivity provided by transparent NTN-based NG-RAN and Cellular NG-RAN: UEs 921B or 922B [symbol] Relay 923B [symbol] sNB 926B [at SATELLITE 925B] [symbol] Edge back-haul CU 930B [symbol] CN 928B [symbol] DN 929B (in this scenario 920B, TN UEs 924B can directly connect to a gNB 927B and the CN 928B, DN 929B via the Edge back-haul CU 930B).

### Further Examples of Exclusion Zones and Exclusion Zone Implementations

An EZ can be defined based on a fixed geographical area using center location coordinates and a radius (or other geometric area/shape around the center location). An EZ can be used to prevent or control transmission of some particular type of radio frequency in the geographical area. As examples, an EZ implementation for coordination with an NTN can be defined to (1) disable the source of transmission in-orbit to prevent transmission over the geographical area, (2) attenuate transmission below a minimum allowed threshold, or (3) steer the satellite beams away from the defined exclusion zone area. An EZ can also be referred to as a prohibited area.

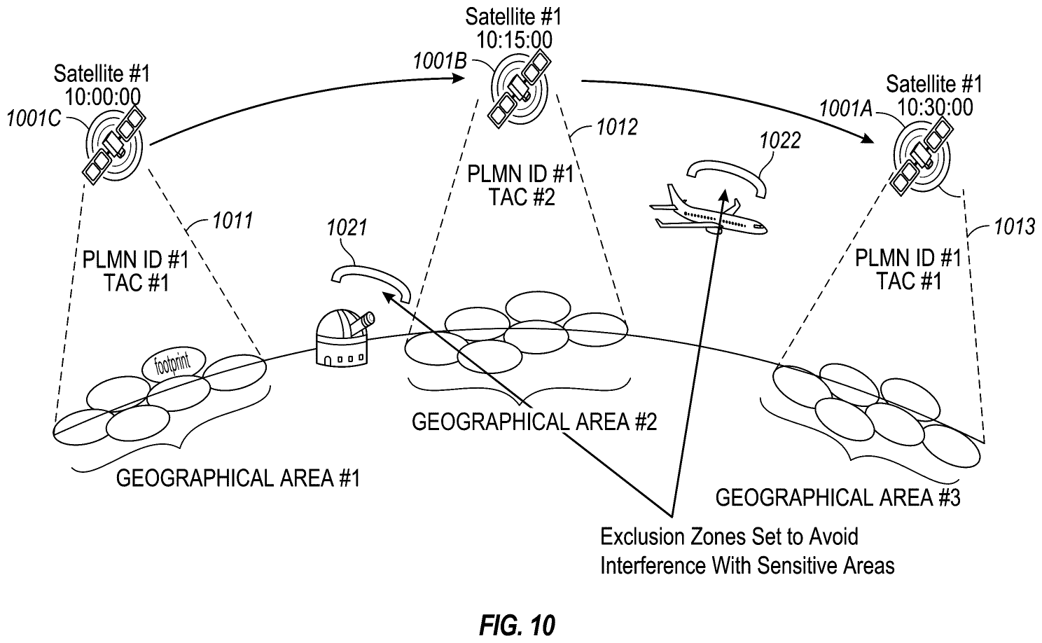

FIG. 10 illustrates an implementation of SV-based exclusion zones for a non-terrestrial communication network, according to an example. This drawing provides additional detail on an example deployment of exclusion zones, over time, relative to a satellite 1001 at orbit positions 1001A, 1001B, 1001C. At position 1001A, the satellite 1001 provides coverage of its spot beam(s) in a first geographic area 1011; at position 1001B, the satellite 1001 provides coverage of its spot beam(s) in a second geographic area 1012; at position 1001C, the satellite 1001 provides coverage of its spot beam(s) in a third geographic area 1013.

FIG. 10 specifically shows the implementation of a first exclusion zone 1021, which is a fixed geographic exclusion area. A fixed geographic exclusion area may be appropriate for preventing overlap with terrestrial networks that would conflict (e.g., cells established from a 4G/5G mobile network), or a fixed area(s) that is designated to instructed to be avoided (e.g., other countries, radio silence areas, sensitive monitoring equipment such as radio telescopes). FIG. 10 further shows the implementation of a second exclusion zone 1022, which is a mobile geographic exclusion area. A mobile geographic area may be appropriate for objects or areas that are in motion, moveable, or whose position is not necessarily fixed in a specific geographic area (e.g., airplanes, drones, other satellites), or for an area that has an irregular or changing shape. The implementation of either type of exclusion zone prevents the satellite from beaming on the area of conflict or restriction.

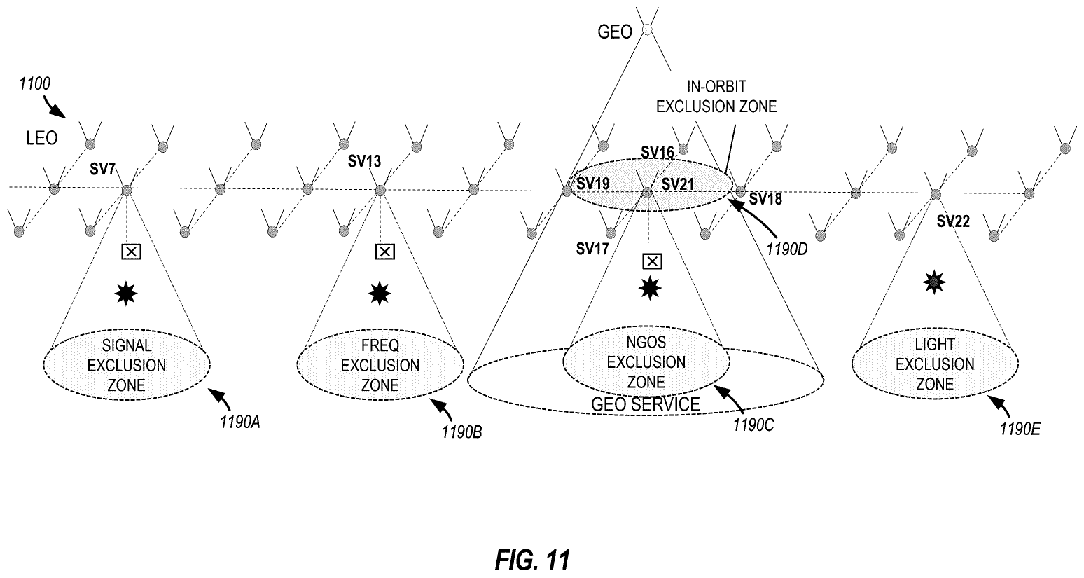

FIG. 11 illustrates further scenarios of network connectivity from an expanded view of a satellite constellation 1100, with the constellation comprising dozens of LEO satellites that provide connectivity to ground UEs (not shown). Within this scenario, a number of different exclusion zones are shown for deployment: a signal exclusion zone 1110A that blocks all signals from reaching a geographic area; a frequency exclusion zone 1110B that blocks certain frequency signals from reaching a geographic area; an non-geostationary orbit satellite (NGOS) exclusion zone 1110C that restricts signals from reaching a certain area which overlaps geostationary satellite service; an in-orbit exclusion zone 1110D which restricts inter-satellite communications which occur in an overlap of geostationary satellite service; and a light pollution exclusion zone 1110E which restricts reflection or causes some light reflection mitigation effect relative to a geographic area. Such exclusion zones 1110A-E may be separately or concurrently deployed with one another.

In the context of FIGS. 10 and 11, exclusion zones and associated feeder links (and link scheduling) can apply to multiple constellations serviced by separate providers. For instance, different constellations may have separate GMSS identifiers (e.g., satellite equivalent of PLMN). Exclusion zones may intercept all applicable constellations, since EZs are typically “fixed” and are independent of the constellation ownership and/or providers.

Pre-determined LEO routing is often used to maintain orbit and ISL connectivity alignment, and may be required to be communicated to the LEO vehicles on a frequent (e.g., daily) basis. Exclusion zones among SVs and ISLs may be implemented to be coordinated with planned network routing calculations and communications that already occur among ground and space nodes of the LEO network. For instance, the regular communication of routing information that is provided to LEO vehicles may also be used to provide a specification of multiple EZs at the same time (including, exclusion zones defined between SV-to-SV (to enable or disable ISLs) or between SV-Earth (to enable or disable geographic coverage)). The definition of exclusion zones with routing information increases efficiency of constellation, especially for form-flying LEO constellations (e.g., similar to Iridium®, Starlink®, and the like).

In an example, exclusion zones can be calculated and provided with orbit and ISL connectivity alignment information. Thus, LEO SVs can be instructed to implement exclusion zones, when receiving instructions to adjust orbital position. Such instructions may include turning various ISL connections on and off, adjusting right, left, fore and aft antennas (regardless or implementation type), if a scenario is projected where an ISL is interfering with a higher-orbit satellite communication (or vice versa). Other considerations established with these exclusion zones may include routing that considers ground and space nodes, including EZs implemented at the same time (whether SV-to-SV or SV-earth exclusion zones), while increasing the efficiency of a constellation. These EZs may also consider that form-flying ISLs antennas often require (1) beam steering, (2) high directivity, and (3) longer ranges and larger apertures than free-flying swarm constellations.

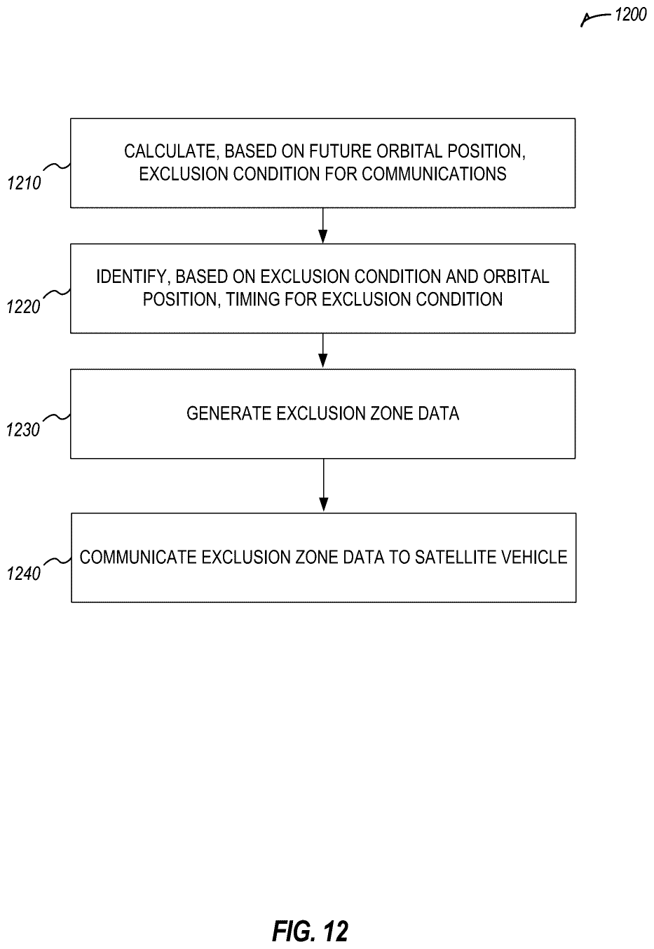

FIG. 12 illustrates a flowchart of an example method 1200 of defining and communicating exclusion zones.

The method begins, at operation 1210, to calculate, based on a future orbital position of a low-earth orbit satellite vehicle, an exclusion condition for communications from the satellite vehicle.

The method continues, at operation 1220, to identify, based on the exclusion condition and the future orbital position, a timing for implementing the exclusion condition for the communications from the satellite vehicle.

The method continues, at operation 1230, to generate exclusion zone data for use by the satellite vehicle. In an example, the exclusion zone data indicates the timing for implementing the exclusion condition for the communications from the satellite vehicle.

The method completes, at operation 1240, to cause communication of the exclusion zone data to the satellite vehicle. In an example, the operations of the method 1230 are performed by a ground-based data processing server at a regular interval, and this communication occurs from the ground-based data processing server to the satellite vehicle. In further examples, the operations of the method 1200 are performed at least in part using computing hardware of the satellite vehicle.

In an example, the exclusion condition of method 1200 is an exclusion of use of a communication frequency onto a terrestrial geographic area. For instance, the exclusion zone data may further identify the communication frequency, and implementation of the exclusion zone data at the satellite vehicle causes the satellite vehicle to discontinue use of the communication frequency while in communication range over the terrestrial geographic area.

In an example, the exclusion condition of method 1200 is an exclusion of use of a spot beam onto a terrestrial geographic area, and the exclusion zone data further identifies the spot beam of the satellite vehicle, as implementation of the exclusion zone data at the satellite vehicle causes the satellite vehicle to discontinue use of the spot beam while in communication range over the terrestrial geographic area.

In an example, the exclusion condition of method 1200 is an exclusion of use of a cellular network coverage at a geographic area, and implementation of the exclusion zone data at the satellite vehicle causes the satellite vehicle to communicate a command to connected user equipment to discontinue use of a satellite network connection while the satellite vehicle is in communication range of the cellular network coverage at the geographic area.

In an example, the exclusion zone data of method 1200 is communicated to the satellite vehicle with a routing table, as the routing table operates to control the future orbital position of the satellite vehicle. In other examples, aspects of a routing protocol, routing protocol data, routing data, or configuration data (e.g., in a particular format) for routing and routing settings may be communicated. In a further example, the exclusion zone data includes attestation or authentication information for verification by the satellite vehicle. Additionally, in a further example, the exclusion zone data may be designated and used by a plurality of satellite vehicles in a constellation including the satellite vehicle.

An Exclusion Zone Protocol (hereinafter, ezP) can be defined and implemented in connection with these and other exclusion zone implementations. The ezP carries information between the NG-RAN and the AMF (or equivalent).

In an example, the ezP is used to support the following EZ functions: 1) Transfer EZ (ezDescription) request from the AMF (or equivalent) to the NG-RAN; 2) Transfer the EZ response from the NG-RAN to the AMF; 3) Exchange information between the NG-RAN and the AMF for the purpose of scheduling an EZ. Other information exchanges may be performed between the AMF and the Satellite Operator.

The ezP may use a variety of exclusion zone Information Elements to define data exchanges and information elements. These information elements may include:

TABLE 1

| | The EZ Definition minimally including ezName, |
|---|---|
| ezDescription (ezD) | ezActivationTime, ezCenter, and ezRadius; |
| ezName | The unique EZ name |
| ezActivationTime | The time period of an EZ |
| ezCenter | The geographical Center Position point of the EZ |
| ezRadius | The geographical radius from EZ Center Position |
| | point of the EZ |
| ezOffsetCenter | Optional, used only when EZ definition type is |
| | “Referenced,” the geographical EZ Offset Center |
| | point position from the EZ Center Position |
| ezOffsetDistance | Optional, used only when EZ definition type is |
| | “Referenced,” the geographical distance from the |
| | EZ Offset center position |
| ezProtocol (ezP): | The EZ Protocol minimally including |
| | ezActivationRequest, and ezActivationResponse |
| ezMethod (ezM) | Requested accommodation method can be either |
| | ezDisable, ezAttenuation or ezBeamsteering |

The ezP may be invoked as the AMF (or equivalent) receives a request to accommodate an ezActivationRequest with a particular ezD. For example, consider a workflow of SAT OPERATOR>EZ ACTIVATION REQUEST>AMF; EZ ACTIVATION REQUEST (ezP IEs: ezD).

The AMF (or equivalent) determines the relevant targeted NG-RAN Node(s) then sends the ezActivationRequest to the relevant targeted ezRanNode(s). An example workflow is: AMF>EZ ACTIVATION REQUEST>NG-RAN(s) EZ ACTIVATION REQUEST (ezP IEs: ezRanNode, ezD).

The NG-RAN processes the ezActivationRequest which may include obtaining and or transferring assistance data, including satellite orbital telemetry to determine which individual satellite(s) ezSATID, ezSATName, with location and status ezSATLocation, ezSATStatus will intercept the EZ request during the ezActivationTime.

The ezMethod is also included to specify the approach used to accommodate the EZ. An example workflow is: NG-RAN>EZ INFORMATION REQUEST>SAT OPERATOR; EZ INFORMATION REQUEST (ezP IEs: ezSATID, ezSATName, ezSATLocation, ezSATStatus, ezMethod).

The NG-RAN determines what individual satellite(s) will intercept ezInterceptSATID(s) the ezActivationRequest and prepares associated scheduling window ezSchedulingWindow to support satellite instructions to accommodate the EZ request. Then the NG-RAN returns the results of the EZ request including the EZ Scheduling window(s) to the AMF for processing. An example workflow is: NG-RAN>EZ INFORMATION RESPONSE>AMF; EZ INFORMATION RESPONSE (ezP IEs: ezInterceptSATID, ezSchedulingWindow).

The AMF provides the EZ Request instructions to the satellite operator including the EZ window used by the satellite operator to enable/disable radio frequency and/or light pollution to satisfy the EZ request.

The satellite operator schedules the appropriate commands within the EZ scheduling window and then informs the AMF the ezActivationResponse ezSucess/ezFailure. An example workflow is: SAT OPERATOR<AMF<EZ ACTIVATION RESPONSE; EZ ACTIVATION RESPONSE (IEs: ezP: ezActivationResponse ezSucess/ezFailure)

An Exclusion Zone Definition (ezD) information element can be defined as a circular or rectangular area. An example of a circular exclusion or Quiet Zone as per FCC § 1.924 could be specified as, for example: 160 km of 64°17′00.0″'N 149°10′00.0″W. A circular ezD can be defined with directly referenced geographical coordinates. An example of a rectangular exclusion or Quiet Zone as per FCC § 1.924 could be specified as: Rectangle 38°40′00″ N. Lat. on the north; 78° 50′00″ W. Long. on the east; 38° 10′00″ N. Lat. on the south; 79°20′00″ W. Long. on the west.

The ezP protocol terminates between the AMF and the NG-RAN and is used as transport for EZ requests and EZ responses messages over the NG-C interface. The NGAP protocol can also be used to instigate and terminate NG-RAN Node related procedures.

As will be understood, standard EZ Descriptions (and Language) can be shared across Terrestrial/Non-Terrestrial Service Providers for consistency and coordination among multiple-5G Terrestrial and geostationary/non-geostationary orbit (NGO) solutions. Implementations of EZs within separate Constellation Providers may vary but EZ Descriptions for ground-based keep-out areas may be sharable across Service Providers, including Cloud and Telecommunication Service Providers. In general, standard “fixed” EZs descriptions can be used to formulate and influence routing and switching payloads to help Service Providers coordinate as the number of NGO satellites and systems increases.

In an example, various commands for exclusion zones may include commands to: Define EZ (to define exclusion zones), Get SV (to obtain SV orbital fly-by information), and Set EZ (to implement an EZ within a constellation). Such commands may be extended for use with constellations, with the following definitions (with “EZn” referring to an identifier of an nth EZ):

Define EZ (Define Exclusion Zone):

TABLE 2

| Parameter | Type | Description |
|---|---|---|
| EZn.ID | INT | EZ Unique ID |
| EZn.NAME | STRING | EZ Name |
| EZn.RADIUS | FLOAT | EZ Radius for KEEP OUT AREA |
| EZn.LAT.PT | FLOAT | EZ Latitude Ground/Sky Center |
| | | Point for KEEP OUT AREA |
| EZn.LONG.PT | FLOAT | EZ Longitude Ground/Sky |
| | | Center Point for KEEP OUT AREA |
| EZn.IP.PT | FLOAT | EZ IP Address Ground/Sky |
| | | Center Point for KEEP OUT AREA |
| EZn.GPS.PT | FLOAT | EZ GPS Ground/Sky Center Point |
| | | for KEEP OUT AREA |
| EZn.MIN.INTENSITY.THRESHOLD | FLOAT | EZ Min Ground/Sky Center Point |
| | | Spot Beam/Freq Intensity |
| | | Threshold |
| EZn.MAX.INTENSITY.THRESHOLD | FLOAT | EZ Max Ground/Sky Center |
| | | Point Spot Beam/Freq Intensity |
| | | Threshold |
| EZn.ISL.TOGGLE | ON/ | EZ Intersatellite Link (ISL) ON or |
| | OFF | OFF |
| EZn.LRM.TOGGLE | ON/ | EZ Light Reflection Mitigation |
| | OFF | (LRM) ON or OFF |
| EZn.SPOT.TOGGLE | ON/ | EZ Spot Beam (SPOT) ON or OFF |
| | OFF | |

Get SV (Get SV Orbital “fly-by” information):

TABLE 3

| Parameter | Type | Description |
|---|---|---|
| SVn.ID.International | STRING | International Designator |
| SVn.ID.NORAD | INT | NORAD Catalog Number |
| SVn.ID.NAME | STRING | SV Name |
| SVn.GND.lat | FLOAT | Ground location latitude for SV fly- |
| | | over |
| SVn.GND.long | FLOAT | Ground location longitude for SV fly- |
| | | over |
| SVn.GND.alt | FLOAT | Ground location altitude % for |
| | | intensity threshold calculations |
| SVn.GND.time | INT | Amount of time to obtain SV |
| | | flyover(s) |
| SVn.Period | Minutes | Location Minutes |
| SVn.Inclination | Degrees | Location Inclination |
| SVn.Apogee.Height | KM | Location Apogee |
| SVn.Perigee.Height | KM | Location Perigee |
| SVn.Eccentricity | FLOAT | Location Eccentricity |

Set EZ (Implement EZ within Constellation):

TABLE 4

| Parameter | Type | Description |
|---|---|---|
| SVn.ID.International | STRING | International Designator |
| SVn.ID.NORAD | INT | NORAD Catalog Number |
| SVn.ID.NAME | STRING | SV Name |
| SVn.SPOTn.TOGGLE | ON/ | SV Spot Beam n Downlink UTC TIME |
| | OFF | START/STOP |
| SVn.SPOTn.FREQn.TOGGLE | ON/ | SV Spot Beam n Frequency n Downlink |
| | OFF | UTC TIME START/STOP |
| SVn.ISL.FORE.TOGGLE | ON/ | SV Intersatellite Link UTC TIME |
| | OFF | START/STOP |
| SVn.ISL.AFT.TOGGLE | ON/ | SV Intersatellite Link UTC TIME |
| | OFF | START/STOP |
| SVn.ISL.RIGHT.TOGGLE | ON/ | SV Intersatellite Link UTC TIME |
| | OFF | START/STOP |
| SVn.ISL.LEFT.TOGGLE | ON/ | SV Intersatellite Link UTC TIME |
| | OFF | START/STOP |
| SVn.SHADE.TOGGLE | ON/ | SV Reflection Shade UTC TIME |
| | OFF | START/STOP |
| SV.EZ.method | INT | ON/OFF or Intensity reduction (e.g., |
| | | based on service provider SLA) |

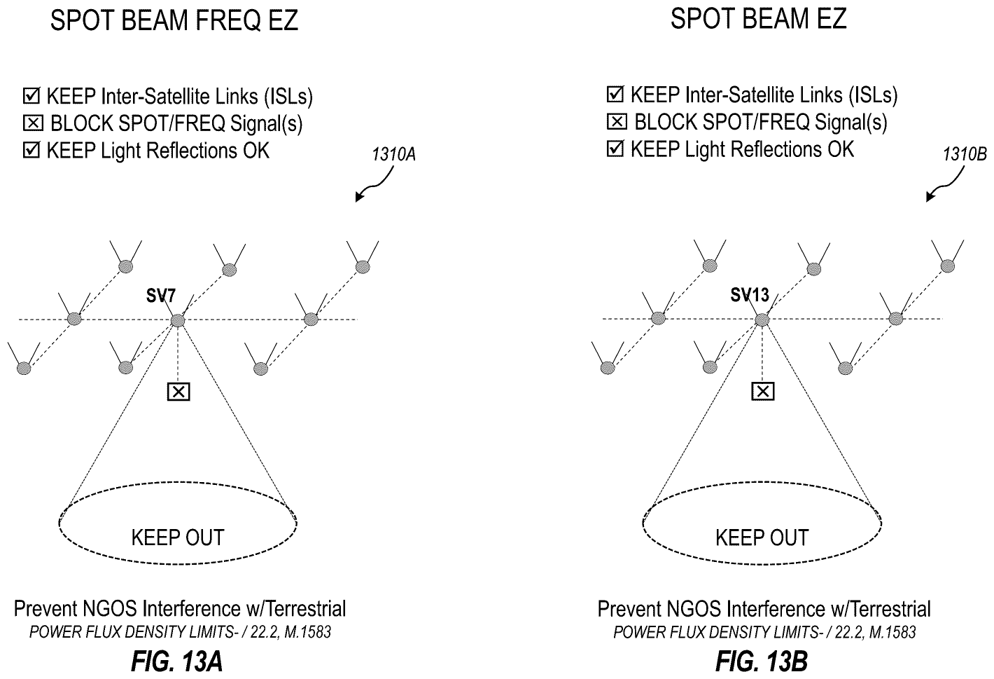

FIG. 13A illustrates further views of an example interference scenario 1310A over a geographic area, and the use of spot beam frequency exclusion zones to implement a keep-out area from SV7. Here, the intent of the EZ is to block specific signals from radiating on the ground, such as where different countries or geographical areas impose different intensity limits. For instance, to implement this exclusion zone based on frequency, values such as the following may be established via the following Define EZ (TABLE 5), Get SV (TABLE 6), and Set EZ (TABLE 7) commands:

TABLE 5
Define EZ (Input)

| Parameter | Value |
|---|---|
| EZn.ID | EZ22.12345 |
| EZn.NAME | EZ22.AZ_GND_{—} |
| | STATION_KO |
| EZn.RADIUS | 100 Meters |
| EZn.LAT.PT | 33.54563 |
| EZn.LONG.PT | −111.97624 |
| EZn.IP.PT | N/A (for this EZ) |
| EZn.GPS.PT | N/A (for this EZ) |
| EZn.MIN.INTENSITY.THRESHOLD | 15% |
| EZn.MAX.INTENSITY.THRESHOLD | 85% |
| EZn.ISL.TOGGLE | ON |
| EZn.LRM.TOGGLE | ON |
| EZn.SPOT.TOGGLE | OFF |

TABLE 6
Get SV (input)

| Parameter | Value |
|---|---|
| SVn.ID.International | 2019-029BD |
| SVn.ID.NORAD | 44286 |
| SVn.ID.NAME | SV7 |
| SVn.GND.lat | calc from below |
| SVn.GND.long | calc from below |
| SVn.GND.alt | calc from below |
| SVn.GND.time | calc from below |
| SVn.Period | 91 |
| SVn.Inclination | 53 |
| SVn.Apogee.Height | 326 |
| SVn.Perigee.Height | 319 |
| SVn.Eccentricity | 0.00056 |

TABLE 7
Set EZ (Output per SV)
(Disable different frequencies in respective spotbeams)

| Parameter | Value |
|---|---|
| SVn.ID.International | 2019-029BD |
| SVn.ID.NORAD | 44286 |
| SVn.ID.NAME | SV7 |
| SVn.SPOTn.TOGGLE | ON |
| SVn.SPOTn.FREQn.TOGGLE | SV7.SPOT1.FREQ2.DISABLE |
| | START 2021-03-03 21:43:56; |
| | STOP 2021-03-03 21:45:06; |
| SVn.ISL.FORE.TOGGLE | ON |
| SVn.ISL.AFT.TOGGLE | ON |
| SVn.ISL.RIGHT.TOGGLE | ON |
| SVn.ISL.LEFT.TOGGLE | ON |
| SVn.SHADE.TOGGLE | ON |
| SV.EZ.method | ON >15% |

FIG. 13B illustrates further views of an example interference scenario 1310B over a geographic area, and the use of combined spot beam frequency exclusion zones to implement a keep-out area of all frequencies from a spot beam of SV13. For instance, to implement this exclusion zone for an entire spot beam, values such as the following may be established via the following Define EZ (TABLE 8), Get SV (TABLE 9), and Set EZ (TABLE 10) commands:

TABLE 8
Define EZ (Input)

| Parameter | Value |
|---|---|
| EZn.ID | EZ22.12345 |
| EZn.NAME | EZ22.AZ_GND_{—} |
| | STATION_KO |
| EZn.RADIUS | 100 Meters |
| EZn.LAT.PT | 33.54563 |
| EZn.LONG.PT | −111.97624 |
| EZn.IP.PT | N/A (for this EZ) |
| EZn.GPS.PT | N/A (for this EZ) |
| EZn.MIN.INTENSITY.THRESHOLD | 15% |
| EZn.MAX.INTENSITY.THRESHOLD | 85% |
| EZn.ISL.TOGGLE | ON |
| EZn.LRM.TOGGLE | ON |
| EZn.SPOT.TOGGLE | OFF |

TABLE 9
Get SV (input)

| Parameter | Value |
|---|---|
| SVn.ID.International | 2019-029BD |
| SVn.ID.NORAD | 44286 |
| SVn.ID.NAME | SV13 |
| SVn.GND.lat | calc from below |
| SVn.GND.long | calc from below |
| SVn.GND.alt | calc from below |
| SVn.GND.time | calc from below |
| SVn.Period | 91 |
| SVn.Inclination | 53 |
| SVn.Apogee.Height | 326 |
| SVn.Perigee.Height | 319 |
| SVn.Eccentricity | 0.00056 |

TABLE 10
Set EZ (Output per SV)
(Disable respective spotbeams)

| Parameter | Value |
|---|---|
| SVn.ID.International | 2019-029BD |
| SVn.ID.NORAD | 44286 |
| SVn.ID.NAME | SV13 |
| SVn.SPOTn.TOGGLE | SV13.SPOT2.DISABLE |
| | START 2021-05-04 22:43:56; |
| | STOP 2021-05-04 22:46:06; |
| SVn.SPOTn.FREQn.TOGGLE | OFF |
| SVn.ISL.FORE.TOGGLE | ON |
| SVn.ISL.AFT.TOGGLE | ON |
| SVn.ISL.RIGHT.TOGGLE | ON |
| SVn.ISL.LEFT.TOGGLE | ON |
| SVn.SHADE.TOGGLE | ON |
| SV.EZ.method | OFF |

It will be understood that other variations to these approaches may be implemented with EZs to block transmissions onto defined areas. For instance, such exclusion zones may provide permutations of a spot beam block, a frequency block within a beam, or an “ignore” setting when the intensity of the spot beam is below the intensity of allowance in the keep out zone.

Similar to the examples above, specific commands and values that define variations of an exclusion zone may be provided in the form of a supplemental space coverage (SCS) coordination zone or inclusion zone. An inclusion zone may be a definition of a specific area that a network (or network frequency) can operate. A coordination zone may be a definition of a specific area that a network (or network frequency) is to coordinate co-existence. An example definition of an EZ/IZ/CZ for a satellite coordination service may include the following information:

TABLE 11

| Parameter | Type | Description |
|---|---|---|
| SCS.ID | INT | EZ/IZ Unique ID |
| SCS.NAME | STRING | EZ/IZ Name |
| SCS.RADIUS | FLOAT | EZ/IZ Radius |
| SCSn.LAT.PT | FLOAT | EZ/IZ Latitude |
| | | Ground/Buffer Center Point |
| SCSn.LONG.PT | FLOAT | EZ/IZ Longitude |
| | | Ground/Buffer Center Point |
| SCSn.IP.PT | FLOAT | EZ/IZ IP Address |
| | | Ground/Buffer Center Point |
| SCSn.GPS.PT | FLOAT | EZ/IZ GPS Ground/Buffer |
| | | Center Point |
| SCSn.MIN.FREQBAND.THRESHOLD | FLOAT | EZ/IZ disallowed Freq Band |
| | | MIN Range |
| SCSn.MAX.FREQBAND.THRESHOLD | FLOAT | EZ/IZ disallowed Freq Band |
| | | MAX Range |
| SCSn.MIN.INTENSITY.THRESHOLD | FLOAT | EZ/IZ Min Ground/Buffer |
| | | Center Point Freq Band/Freq |
| | | Intensity Threshold |
| SCSn.MAX.INTENSITY.THRESHOLD | FLOAT | EZ/IZ Max Ground/Buffer |
| | | Center Point Freq Band/Freq |
| | | Intensity Threshold |
| SCSn.MIN.Weather.THRESHOLD | FLOAT | EZ/IZ Min physical env |
| | | weather Threshold |
| SCSn.MAX.Weather.THRESHOLD | FLOAT | EZ/IZ Max physical env |
| | | weather Threshold (e.g, |
| | | hurricane category 2 wind |
| | | sheer >10 mph) |
| SCSn.OTHER.THRESHOLD | FLOAT | EZ/IZ OTHER OPEN variable |
| SCSn.RADIO.TOGGLE | ON/OFF | EZ/IZ Radio ON or OFF |
| SCS_ZONE.BER | | Bit Error Rate |
| SCS_ZONE.CNR | | Carrier to Noise Ratio |
| SCS_ZONE.PFD | | Power Flux Density |
| SCS_ZONE.RIP | | Received isotropic power |
| SCS_ZONE.EIRP | | Effective isotropic radiated |
| | | power |
| SCS_ZONE.AG | | Antenna Gain |
| SCS_ZONE_Proximity | | Debris and or other |
| Constraint | | Proximity Alerts or Keep |
| | | Outs |

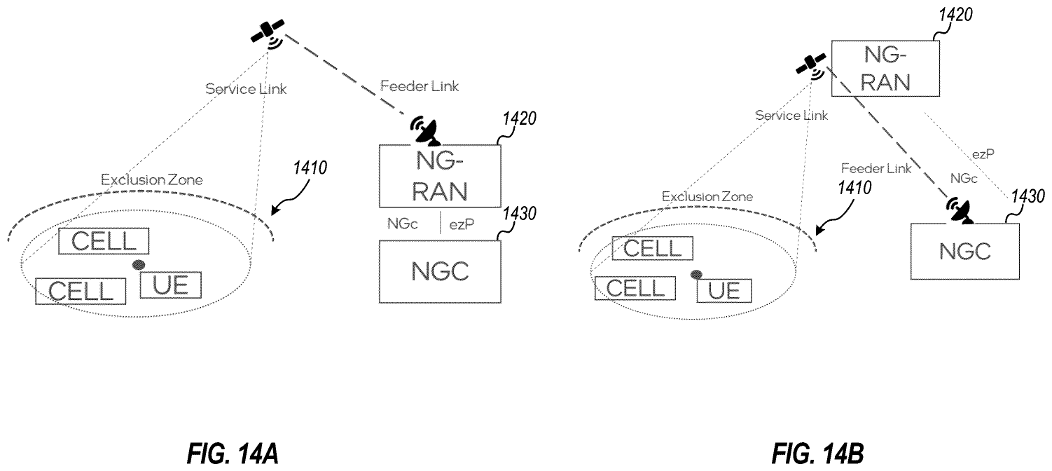

FIGS. 14A and 14B illustrate further views of exclusion zones implemented for transmissions from a non-terrestrial communication network. In these examples, an AMF may have proprietary signaling connection between an NGC (Next Generation Core) and the satellite operator. Details of the signaling interaction between the AMF and the satellite operator may vary.

In FIG. 14A, an EZ 1410 is defined to prevent interference from a service link provided from the LEO satellite to a geographic area on earth. This information is provided from use of an exclusion zone protocol (ezP) from an NGC 1430 and an NG-RAN 1420. In FIG. 14B, a similar EZ is defined, but is provided from the NGC 1430 on-Earth to an NG-RAN 1420 operating in the NTN.

In further examples, the EZ can be defined not only to prevent interference from the LEO satellite to Earth via the service link, but also to modify operation of the feeder link to prevent interference from the LEO satellite to Earth. Accordingly, aspects of the ezP, the ezD, and exclusion/inclusion/coordination features can be defined for the service link and for the feeder link.

### Implementation in Computing Hardware and Edge Computing Scenarios

It will be understood that the present communication and networking arrangements may be integrated with many aspects of edge computing strategies and deployments. Edge computing, at a general level, refers to the transition of compute and storage resources closer to endpoint devices (e.g., consumer computing devices, user equipment, etc.) in order to optimize total cost of ownership, reduce application latency, improve service capabilities, and improve compliance with security or data privacy requirements. Edge computing may, in some scenarios, provide a cloud-like distributed service that offers orchestration and management for applications among many types of storage and compute resources. As a result, some implementations of edge computing have been referred to as the “edge cloud” or the “fog”, as powerful computing resources previously available only in large remote data centers are moved closer to endpoints and made available for use by consumers at the “edge” of the network.

In the context of satellite communication networks, edge computing operations may occur, as discussed above, by: moving workloads onto compute equipment at satellite vehicles; using satellite connections to offer backup or (redundant) links and connections to lower-latency services; coordinating workload processing operations at terrestrial access points or base stations; providing data and content via satellite networks; and the like. Thus, many of the same edge computing scenarios that are described below for mobile networks and mobile client devices are equally applicable when using a non-terrestrial network.

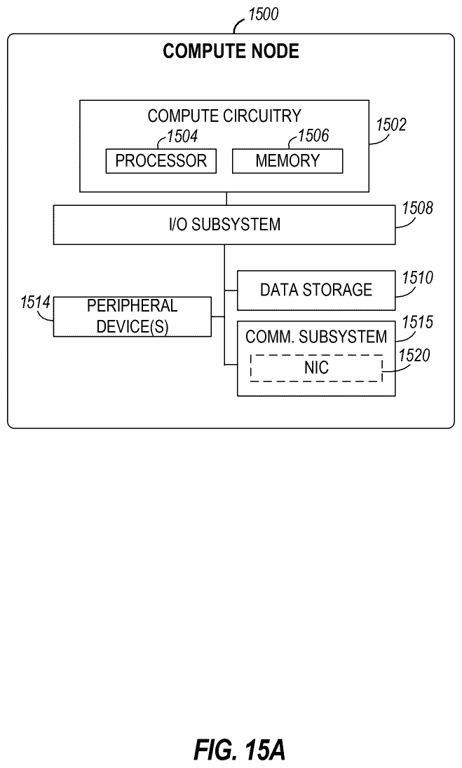

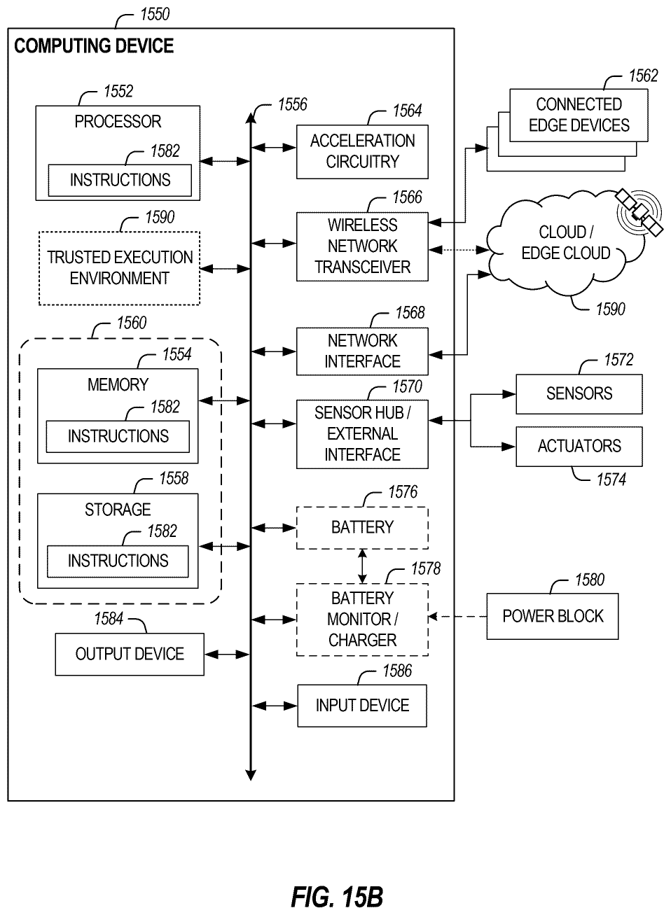

In various examples, any of the compute nodes or devices discussed with reference to the present computing systems and environment may be fulfilled based on the components depicted in FIGS. 15A and 15B. A respective compute node may be embodied as a type of device, appliance, computer, or other “thing” capable of communicating with other edge, networking, or endpoint components.

In the simplified example depicted in FIG. 15A, an edge compute node 1500 includes a compute engine (also referred to herein as “compute circuitry”) 1502, an input/output (I/O) subsystem 1508, data storage device 1510, a communication circuitry 1512 subsystem, and, optionally, one or more peripheral devices 1514. In other examples, a compute device may include other or additional components, such as those used in personal or server computing systems (e.g., a display, peripheral devices, etc.). Additionally, in some examples, one or more of the illustrative components may be incorporated in, or otherwise form a portion of, another component.

The compute node 1500 may be embodied as any type of engine, device, or collection of devices capable of performing various compute functions. In some examples, the compute node 1500 may be embodied as a single device such as an integrated circuit, an embedded system, a field-programmable gate array (FPGA), a system-on-a-chip (SOC), or other integrated system or device. In the illustrative example, the compute node 1500 includes or is embodied as a processor 1504 and a memory 1506. The processor 1504 may be embodied as any type of processor capable of performing the functions described herein (e.g., executing an application). For example, the processor 1504 may be embodied as a multi-core processor(s), a microcontroller, or other processor or processing/controlling circuit. In some examples, the processor 1504 may be embodied as, include, or be coupled to an FPGA, an application specific integrated circuit (ASIC), reconfigurable hardware or hardware circuitry, or other specialized hardware to facilitate performance of the functions described herein.

The main memory 1506 may be embodied as any type of volatile (e.g., dynamic random access memory (DRAM), etc.) or non-volatile memory or data storage capable of performing the functions described herein, with either type of volatile or non-volatile memory constituting a machine-readable storage medium. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM).

In one example, the memory device is a block addressable memory device, such as those based on NAND or NOR technologies. A memory device may also include a three-dimensional crosspoint memory device (e.g., Intel 3D XPoint™ memory, other storage class memory), or other byte addressable write-in-place nonvolatile memory devices. The memory device may refer to the die itself and/or to a packaged memory product. In some examples, 3D crosspoint memory (e.g., Intel 3D XPoint™ memory) may comprise a transistor-less stackable cross point architecture in which memory cells sit at the intersection of word lines and bit lines and are individually addressable and in which bit storage is based on a change in bulk resistance. In some examples, all or a portion of the main memory 1506 may be integrated into the processor 1504. The main memory 1506 may store various software and data used during operation such as one or more applications, data operated on by the application(s), libraries, and drivers.

The compute circuitry 1502 is communicatively coupled to other components of the compute node 1500 via the I/O subsystem 1508, which may be embodied as circuitry and/or components to facilitate input/output operations with the compute circuitry 1502 (e.g., with the processor 1504 and/or the main memory 1506) and other components of the compute circuitry 1502. For example, the I/O subsystem 1508 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 1508 may form a portion of a system-on-a-chip (SoC) and be incorporated, along with one or more of the processor 1504, the main memory 1506, and other components of the compute circuitry 1502, into the compute circuitry 1502.

The one or more illustrative data storage devices 1510 may be embodied as any type of devices configured for short-term or long-term storage of data such as, for example, memory devices and circuits, memory cards, hard disk drives, solid-state drives, or other data storage devices. A data storage device 1510 may include a system partition that stores data and firmware code for the data storage device 1510. A data storage device 1510 may also include one or more operating system partitions that store data files and executables for operating systems depending on, for example, the type of compute node 1500.

The communication circuitry 1512 may be embodied as any communication circuit, device, or collection thereof, capable of enabling communications over a network between the compute circuitry 1502 and another compute device (e.g., an edge gateway node 2012 of an edge computing system). The communication circuitry 1512 may be configured to use any one or more communication technology (e.g., wired or wireless communications) and associated protocols (e.g., a cellular networking protocol such a 3GPP 4G or 5G standard, a wireless local area network protocol such as IEEE 802.11/Wi-Fi®, a wireless wide area network protocol, Ethernet, Bluetooth®, etc.) to effect such communication.

The communication circuitry 1512 includes a network interface controller (NIC) 1520, which may also be referred to as a host fabric interface (HFI). The NIC 1520 may be embodied as one or more add-in-boards, daughter cards, network interface cards, controller chips, chipsets, or other devices that may be used by the compute node 1500 to connect with another compute device (e.g., an edge gateway node 2012). In some examples, the NIC 1520 may be embodied as part of a system-on-a-chip (SoC) that includes one or more processors, or included on a multichip package that also contains one or more processors. In some examples, the NIC 1520 may include a local processor (not shown) and/or a local memory (not shown) that are both local to the NIC 1520. In such examples, the local processor of the NIC 1520 may be capable of performing one or more of the functions of the compute circuitry 1502 described herein. Additionally or alternatively, in such examples, the local memory of the NIC 1520 may be integrated into one or more components of the client compute node at the board level, socket level, chip level, and/or other levels.

Additionally, in some examples, a compute node 1500 may include one or more peripheral devices 1514. Such peripheral devices 1514 may include any type of peripheral device found in a compute device or server such as audio input devices, a display, other input/output devices, interface devices, and/or other peripheral devices, depending on the particular type of the compute node 1500. In further examples, the compute node 1500 may be embodied by a respective edge compute node in an edge computing system (e.g., client compute node 2002, edge gateway node 2012, edge aggregation node 2022) or like forms of appliances, computers, subsystems, circuitry, or other components.

In a more detailed example, FIG. 15B illustrates a block diagram of an example of components that may be present in an edge computing node 1550 for implementing the techniques (e.g., operations, processes, methods, and methodologies) described herein. The edge computing node 1550 may include any combinations of the components referenced above, and it may include any device usable with an edge communication network or a combination of such networks. The components may be implemented as ICs, portions thereof, discrete electronic devices, or other modules, logic, hardware, software, firmware, or a combination thereof adapted in the edge computing node 1550, or as components otherwise incorporated within a chassis of a larger system. Further, to support the security examples provided herein, a hardware ROT (e.g., provided according to a DICE architecture) may be implemented in a respective IP block of the edge computing node 1550 such that any IP Block could boot into a mode where a RoT identity could be generated that may attest its identity and its current booted firmware to another IP Block or to an external entity.

The edge computing node 1550 may include processing circuitry in the form of a processor 1552, which may be a microprocessor, a multi-core processor, a multithreaded processor, an ultra-low voltage processor, an embedded processor, or other known processing elements. The processor 1552 may be a part of a system on a chip (SoC) in which the processor 1552 and other components are formed into a single integrated circuit, or a single package, such as the Edison™ or Galileo™ SoC boards from Intel Corporation, Santa Clara, California. As an example, the processor 1552 may include an Intel® Architecture Core™ based processor, such as a Quark™, an Atom™, a Xeon™ an i3, an i5, an i7, an i9, or an MCU-class processor, or another such processor available from Intel®. However, any number other processors may be used, such as available from Advanced Micro Devices, Inc. (AMD) of Sunnyvale, California, a MIPS-based design from MIPS Technologies, Inc. of Sunnyvale, California, an ARM-based design licensed from ARM Holdings, Ltd. or a customer thereof, or their licensees or adopters. The processors may include units such as an A5-A13 processor from Apple® Inc., a Snapdragon™ processor from Qualcomm® Technologies, Inc., or an OMAP™ processor from Texas Instruments, Inc.

The processor 1552 may communicate with a system memory 1554 over an interconnect 1556 (e.g., a bus). Any number of memory devices may be used to provide for a given amount of system memory. As examples, the memory may be random access memory (RAM) in accordance with a Joint Electron Devices Engineering Council (JEDEC) design such as the DDR or mobile DDR standards (e.g., LPDDR, LPDDR2, LPDDR3, or LPDDR4). In particular examples, a memory component may comply with a DRAM standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces. In various implementations, the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems and so forth, a storage 1558 may also couple to the processor 1552 via the interconnect 1556. In an example, the storage 1558 may be implemented via a solid-state disk drive (SSDD). Other devices that may be used for the storage 1558 include flash memory cards, such as SD cards, microSD cards, XD picture cards, and the like, and USB flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magneto-resistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

In low power implementations, the storage 1558 may be on-die memory or registers associated with the processor 1552. However, in some examples, the storage 1558 may be implemented using a micro hard disk drive (HDD). Further, any number of new technologies may be used for the storage 1558 in addition to, or instead of, the technologies described, such resistance change memories, phase change memories, holographic memories, or chemical memories, among others.

The components may communicate over the interconnect 1556. The interconnect 1556 may include any number of technologies, including industry standard architecture (ISA), extended ISA (EISA), peripheral component interconnect (PCI), peripheral component interconnect extended (PCIx), PCI express (PCIe), NVLink, or any number of other technologies. The interconnect 1556 may be a proprietary bus, for example, used in an SoC based system. Other bus systems may be included, such as an I2C interface, an SPI interface, point to point interfaces, and a power bus, among others.

The interconnect 1556 may couple the processor 1552 to a transceiver 1566, for communications with the connected edge devices 1562. The transceiver 1566 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected edge devices 1562. For example, a wireless local area network (WLAN) unit may be used to implement Wi-Fi® communications in accordance with the Institute of Electrical and Electronics Engineers (IEEE) 802.11 standard. In addition, wireless wide area communications, e.g., according to a cellular or other wireless wide area protocol, may occur via a wireless wide area network (WWAN) unit.

The wireless network transceiver 1566 (or multiple transceivers) may communicate using multiple standards or radios for communications at a different range. For example, the edge computing node 1550 may communicate with close devices, e.g., within about 10 meters, using a local transceiver based on BLE, or another low power radio, to save power. More distant connected edge devices 1562, e.g., within about 50 meters, may be reached over ZigBee or other intermediate power radios. Both communications techniques may take place over a single radio at different power levels or may take place over separate transceivers, for example, a local transceiver using BLE and a separate mesh transceiver using ZigBee.

A wireless network transceiver 1566 (e.g., a radio transceiver) may be included to communicate with devices or services in the edge cloud 1590 via local or wide area network protocols. The wireless network transceiver 1566 may be an LPWA transceiver that follows the IEEE 802.15.4, or IEEE 802.15.4g standards, among others. The edge computing node 1550 may communicate over a wide area using LoRaWAN™ (Long Range Wide Area Network) developed by Semtech and the LoRa Alliance. The techniques described herein are not limited to these technologies but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the wireless network transceiver 1566, as described herein. For example, the transceiver 1566 may include a cellular transceiver that uses spread spectrum (SPA/SAS) communications for implementing high-speed communications. Further, any number of other protocols may be used, such as Wi-Fi® networks for medium speed communications and provision of network communications. The transceiver 1566 may include radios that are compatible with any number of 3GPP (Third Generation Partnership Project) specifications, such as Long Term Evolution (LTE) and 5th Generation (5G) communication systems, discussed in further detail at the end of the present disclosure. A network interface controller (NIC) 1568 may be included to provide a wired communication to nodes of the edge cloud 1590 or to other devices, such as the connected edge devices 1562 (e.g., operating in a mesh). The wired communication may provide an Ethernet connection or may be based on other types of networks, such as Controller Area Network (CAN), Local Interconnect Network (LIN), DeviceNet, ControlNet, Data Highway+, PROFIBUS, or PROFINET, among many others. An additional NIC 1568 may be included to enable connecting to a second network, for example, a first NIC 1568 providing communications to the cloud over Ethernet, and a second NIC 1568 providing communications to other devices over another type of network.

Given the variety of types of applicable communications from the device to another component or network, applicable communications circuitry used by the device may include or be embodied by any one or more of components in circuitry 1564, transceiver 1566, NIC 1568, or interface 1570. Accordingly, in various examples, applicable means for communicating (e.g., receiving, transmitting, etc.) may be embodied by such communications circuitry.

The edge computing node 1550 may include or be coupled to acceleration circuitry 1564, which may be embodied by one or more AI accelerators, a neural compute stick, neuromorphic hardware, an FPGA, an arrangement of GPUs, one or more SoCs, one or more CPUs, one or more digital signal processors, dedicated ASICs, or other forms of specialized processors or circuitry designed to accomplish one or more specialized tasks. These tasks may include AI processing (including machine learning, training, inferencing, and classification operations), visual data processing, network data processing, object detection, rule analysis, or the like. Accordingly, in various examples, applicable means for acceleration may be embodied by such acceleration circuitry.

The interconnect 1556 may couple the processor 1552 to a sensor hub or external interface 1570 that is used to connect additional devices or subsystems. The devices may include sensors 1572, such as accelerometers, level sensors, flow sensors, optical light sensors, camera sensors, temperature sensors, a global positioning system (GPS) sensors, pressure sensors, barometric pressure sensors, and the like. The hub or interface 1570 further may be used to connect the edge computing node 1550 to actuators 1574, such as power switches, valve actuators, an audible sound generator, a visual warning device, and the like.

In some optional examples, various input/output (I/O) devices may be present within or connected to, the edge computing node 1550. For example, a display or other output device 1584 may be included to show information, such as sensor readings or actuator position. An input device 1586, such as a touch screen or keypad may be included to accept input. An output device 1584 may include any number of forms of audio or visual display, including simple visual outputs such as binary status indicators (e.g., LEDs) and multi-character visual outputs, or more complex outputs such as display screens (e.g., LCD screens), with the output of characters, graphics, multimedia objects, and the like being generated or produced from the operation of the edge computing node 1550.

A battery 1576 may power the edge computing node 1550, although, in examples in which the edge computing node 1550 is mounted in a fixed location, it may have a power supply coupled to an electrical grid. The battery 1576 may be a lithium ion battery, or a metal-air battery, such as a zinc-air battery, an aluminum-air battery, a lithium-air battery, and the like.

A battery monitor/charger 1578 may be included in the edge computing node 1550 to track the state of charge (SoCh) of the battery 1576. The battery monitor/charger 1578 may be used to monitor other parameters of the battery 1576 to provide failure predictions, such as the state of health (SoH) and the state of function (SoF) of the battery 1576. The battery monitor/charger 1578 may include a battery monitoring integrated circuit, such as an LTC4020 or an LTC2990 from Linear Technologies, an ADT7488A from ON Semiconductor of Phoenix Arizona, or an IC from the UCD90xxx family from Texas Instruments of Dallas, TX. The battery monitor/charger 1578 may communicate the information on the battery 1576 to the processor 1552 over the interconnect 1556. The battery monitor/charger 1578 may also include an analog-to-digital (ADC) converter that enables the processor 1552 to directly monitor the voltage of the battery 1576 or the current flow from the battery 1576. The battery parameters may be used to determine actions that the edge computing node 1550 may perform, such as transmission frequency, mesh network operation, sensing frequency, and the like.

A power block 1580, or other power supply coupled to a grid, may be coupled with the battery monitor/charger 1578 to charge the battery 1576. In some examples, the power block 1580 may be replaced with a wireless power receiver to obtain the power wirelessly, for example, through a loop antenna in the edge computing node 1550. A wireless battery charging circuit, such as an LTC4020 chip from Linear Technologies of Milpitas, California, among others, may be included in the battery monitor/charger 1578. The specific charging circuits may be selected based on the size of the battery 1576, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 1558 may include instructions 1582 in the form of software, firmware, or hardware commands to implement the techniques described herein. Although such instructions 1582 are shown as code blocks included in the memory 1554 and the storage 1558, it may be understood that any of the code blocks may be replaced with hardwired circuits, for example, built into an application specific integrated circuit (ASIC).

In an example, the instructions 1582 provided via the memory 1554, the storage 1558, or the processor 1552 may be embodied as a non-transitory, machine-readable medium 1560 including code to direct the processor 1552 to perform electronic operations in the edge computing node 1550. The processor 1552 may access the non-transitory, machine-readable medium 1560 over the interconnect 1556. For instance, the non-transitory, machine-readable medium 1560 may be embodied by devices described for the storage 1558 or may include specific storage units such as optical disks, flash drives, or any number of other hardware devices. The non-transitory, machine-readable medium 1560 may include instructions to direct the processor 1552 to perform a specific sequence or flow of actions, for example, as described with respect to the flowchart(s) and block diagram(s) of operations and functionality depicted above. As used in, the terms “machine-readable medium” and “computer-readable medium” are interchangeable.

In further examples, a machine-readable medium also includes any tangible medium that is capable of storing, encoding or carrying instructions for execution by a machine and that cause the machine to perform any one or more of the methodologies of the present disclosure or that is capable of storing, encoding or carrying data structures utilized by or associated with such instructions. A “machine-readable medium” thus may include but is not limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of a number of transfer protocols (e.g., HTTP).

A machine-readable medium may be provided by a storage device or other apparatus which is capable of hosting data in a non-transitory format. In an example, information stored or otherwise provided on a machine-readable medium may be representative of instructions, such as instructions themselves or a format from which the instructions may be derived. This format from which the instructions may be derived may include source code, encoded instructions (e.g., in compressed or encrypted form), packaged instructions (e.g., split into multiple packages), or the like. The information representative of the instructions in the machine-readable medium may be processed by processing circuitry into the instructions to implement any of the operations discussed herein. For example, deriving the instructions from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions.

In an example, the derivation of the instructions may include assembly, compilation, or interpretation of the information (e.g., by the processing circuitry) to create the instructions from some intermediate or preprocessed format provided by the machine-readable medium. The information, when provided in multiple parts, may be combined, unpacked, and modified to create the instructions. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable, etc.) at a local machine, and executed by the local machine.

Each of the block diagrams of FIGS. 15A and 15B are intended to depict a high-level view of components of a device, subsystem, or arrangement of an edge computing node. However, it will be understood that some of the components shown may be omitted, additional components may be present, and a different arrangement of the components shown may occur in other implementations.

FIG. 1610 illustrates an example software distribution platform 1605 to distribute software, such as the example computer readable instructions 1582 of FIG. 15B, to one or more devices, such as example processor platform(s) 1610 and/or other example connected edge devices or systems discussed herein. The example software distribution platform 1605 may be implemented by any computer server, data facility, cloud service, etc., capable of storing and transmitting software to other computing devices. Example connected edge devices may be customers, clients, managing devices (e.g., servers), third parties (e.g., customers of an entity owning and/or operating the software distribution platform 1605). Example connected edge devices may operate in commercial and/or home automation environments. In some examples, a third party is a developer, a seller, and/or a licensor of software such as the example computer readable instructions 1582 of FIG. 15B. The third parties may be consumers, users, retailers, OEMs, etc. that purchase and/or license the software for use and/or re-sale and/or sub-licensing. In some examples, distributed software causes display of one or more user interfaces (UIs) and/or graphical user interfaces (GUIs) to identify the one or more devices (e.g., connected edge devices) geographically and/or logically separated from each other (e.g., physically separated IoT devices chartered with the responsibility of water distribution control (e.g., pumps), electricity distribution control (e.g., relays), etc.).

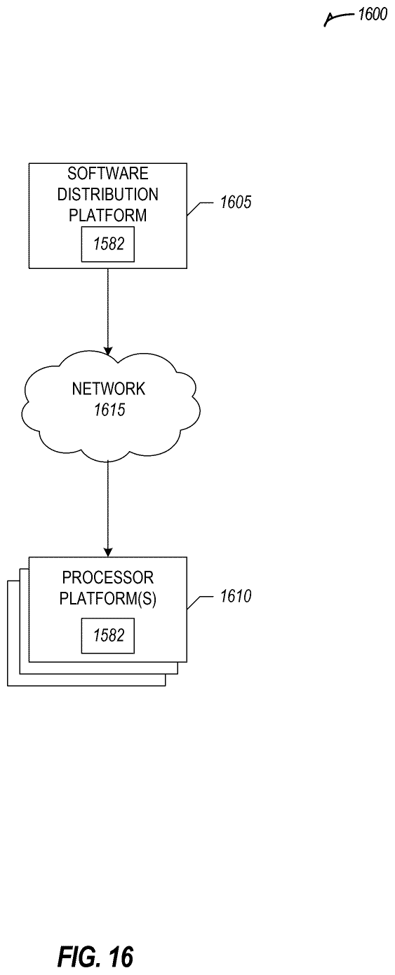

In the illustrated example of FIG. 16, the software distribution platform 1605 includes one or more servers and one or more storage devices that store the computer readable instructions 1582. The one or more servers of the example software distribution platform 1605 are in communication with a network 1615, which may correspond to any one or more of the Internet and/or any of the example networks described above. In some examples, the one or more servers are responsive to requests to transmit the software to a requesting party as part of a commercial transaction. Payment for the delivery, sale and/or license of the software may be handled by the one or more servers of the software distribution platform and/or via a third-party payment entity. The servers enable purchasers and/or licensors to download the computer readable instructions 1582 from the software distribution platform 1605. For example, the software, which may correspond to example computer readable instructions, may be downloaded to the example processor platform(s), which is/are to execute the computer readable instructions 1582. In some examples, one or more servers of the software distribution platform 1605 are communicatively connected to one or more security domains and/or security devices through which requests and transmissions of the example computer readable instructions 1582 must pass. In some examples, one or more servers of the software distribution platform 1605 periodically offer, transmit, and/or force updates to the software (e.g., the example computer readable instructions 1582 of FIG. 15B) to ensure improvements, patches, updates, etc. are distributed and applied to the software at the end user devices.

In the illustrated example of FIG. 16, the computer readable instructions 1582 are stored on storage devices of the software distribution platform 1605 in a particular format. A format of computer readable instructions includes, but is not limited to a particular code language (e.g., Java, JavaScript, Python, C, C#, SQL, HTML, etc.), and/or a particular code state (e.g., uncompiled code (e.g., ASCII), interpreted code, linked code, executable code (e.g., a binary), etc.). In some examples, the computer readable instructions 1582 stored in the software distribution platform 1605 are in a first format when transmitted to the example processor platform(s) 1610. In some examples, the first format is an executable binary in which particular types of the processor platform(s) 1610 can execute. However, in some examples, the first format is uncompiled code that requires one or more preparation tasks to transform the first format to a second format to enable execution on the example processor platform(s) 1610. For instance, the receiving processor platform(s) 1600 may need to compile the computer readable instructions 1582 in the first format to generate executable code in a second format that is capable of being executed on the processor platform(s) 1610. In still other examples, the first format is interpreted code that, upon reaching the processor platform(s) 1610, is interpreted by an interpreter to facilitate execution of instructions.

### Example Implementation Systems and Methods

Additional examples of the presently described method, system, and device embodiments include the following, non-limiting implementations. Each of the following non-limiting examples may stand on its own or may be combined in any permutation or combination with any one or more of the other examples provided below or throughout the present disclosure.

Example 1 is a method of configuring a floating ground station for connectivity with a satellite non-terrestrial network (NTN), the method comprising: receiving configuration information for a compute node to be operated as a temporary NTN ground station, the compute node located on a marine vessel capable of transiting among multiple marine locations, and the compute node having connectivity to the satellite NTN via a feeder link; configuring the compute node to operate as the temporary NTN ground station, based on the configuration information, the temporary NTN ground station configured to process data from satellite terminals of the satellite NTN; and modifying the feeder link to perform data communications between the temporary NTN ground station and respective orbiting satellites of the satellite NTN, the feeder link being dynamically modified based on network usage and restrictions applicable to a geographic location of the marine vessel.

In Example 2, the subject matter of Example 1 optionally includes wherein the feeder link has a fixed bandwidth, and wherein allocation of data includes respective allocations among: user plane data, control plane data, and Operations, Administration, and Maintenance (OAM) data.

In Example 3, the subject matter of Example 2 optionally includes wherein the respective allocations are adjusted based on operational conditions of the satellite NTN and data usage from one or more data networks hosted by the marine vessel.

In Example 4, the subject matter of any one or more of Examples 2-3 optionally include wherein the respective allocations are adjusted based on one or more connection health metrics provided from among: upload block error rate, download block error rate or cyclic redundancy check (CRC) results.

In Example 5, the subject matter of any one or more of Examples 1-4 optionally include wherein the compute node is selected to be operated as the temporary NTN ground station based on utilization metrics of one or more other NTN ground stations.

In Example 6, the subject matter of Example 5 optionally includes discontinuing use of the compute node as the temporary NTN ground station, based on a decrease in the utilization metrics of the one or more other NTN ground stations.

In Example 7, the subject matter of any one or more of Examples 1-6 optionally include wherein the compute node is operated as the temporary NTN ground station when the marine vessel is undocked in a port geographic area, and wherein the temporary NTN ground station serves as a network gateway based on a wireless backhaul to an onshore network.

In Example 8, the subject matter of Example 7 optionally includes wherein the compute node is operated as the temporary NTN ground station when the marine vessel is docked in the port geographic area, and wherein the temporary NTN ground station serves as the network gateway based on a wired backhaul when the marine vessel is docked.

In Example 9, the subject matter of any one or more of Examples 1-8 optionally include wherein the restrictions applicable to the geographic location of the marine vessel are based on an exclusion zone, wherein the exclusion zone defines one or more geographical areas of restricted wireless communications for the feeder link between the satellite NTN and the marine vessel.

In Example 10, the subject matter of Example 9 optionally includes wherein the exclusion zone defines one or more mitigations for use for transmissions from the satellite NTN, the one or more mitigations provided from among: spot beam control, frequency change, or beamsteering.

Example 11 is a device, comprising: processing circuitry; and a machine-readable medium (e.g., memory device) including instructions embodied thereon, wherein the instructions, when executed by the processing circuitry, configure the processing circuitry to cause operations that: receive configuration information for a compute node to be operated as a temporary non-terrestrial network (NTN) ground station, the compute node located on a marine vessel capable of transiting among multiple marine locations, and the compute node having connectivity to a satellite NTN via a feeder link; configure the compute node to operate as the temporary NTN ground station, based on the configuration information, the temporary NTN ground station configured to process data from satellite terminals of the satellite NTN; and modify the feeder link to perform data communications between the temporary NTN ground station and respective orbiting satellites of the satellite NTN, the feeder link being dynamically modified based on network usage and restrictions applicable to a geographic location of the marine vessel.

In Example 12, the subject matter of Example 11 optionally includes wherein the feeder link has a fixed bandwidth, and wherein allocation of data includes respective allocations among: user plane data, control plane data, and Operations, Administration, and Maintenance (OAM) data.

In Example 13, the subject matter of Example 12 optionally includes wherein the respective allocations are adjusted based on operational conditions of the satellite NTN and data usage from one or more data networks hosted by the marine vessel.

In Example 14, the subject matter of any one or more of Examples 12-13 optionally include wherein the respective allocations are adjusted based on one or more connection health metrics provided from among: upload block error rate, download block error rate or cyclic redundancy check (CRC) results.

In Example 15, the subject matter of any one or more of Examples 11-14 optionally include wherein the compute node is selected to be operated as the temporary NTN ground station based on utilization metrics of one or more other NTN ground stations.

In Example 16, the subject matter of Example 15 optionally includes wherein the instructions further configure the processing circuitry to cause operations that: discontinue use of the compute node as the temporary NTN ground station, based on a decrease in the utilization metrics of the one or more other NTN ground stations.

In Example 17, the subject matter of any one or more of Examples 11-16 optionally include wherein the compute node is operated as the temporary NTN ground station when the marine vessel is undocked in a port geographic area, and wherein the temporary NTN ground station serves as a network gateway based on a wireless backhaul to an onshore network.

In Example 18, the subject matter of Example 17 optionally includes wherein the compute node is operated as the temporary NTN ground station when the marine vessel is docked in the port geographic area, and wherein the temporary NTN ground station serves as the network gateway based on a wired backhaul when the marine vessel is docked.

In Example 19, the subject matter of any one or more of Examples 11-18 optionally include wherein the restrictions applicable to the geographic location of the marine vessel are based on an exclusion zone, wherein the exclusion zone defines one or more geographical areas of restricted wireless communications for the feeder link between the satellite NTN and the marine vessel.

In Example 20, the subject matter of Example 19 optionally includes wherein the exclusion zone defines one or more mitigations for use for transmissions from the satellite NTN, the one or more mitigations provided from among: spot beam control, frequency change, or beamsteering.

Example 21 is a device, comprising: processing circuitry; and a memory device including instructions embodied thereon, wherein the instructions, which when executed by the processing circuitry, configure the processing circuitry to perform operations for configuring or operating a floating satellite network ground station, optionally with use of adaptable feeder links, in accordance with Examples 1-20 or the other examples discussed herein.

Example 22 is a method, comprising a plurality of operations executed with a processor and memory of a device, to perform operations for configuring or operating a floating satellite network ground station, optionally with use of adaptable feeder links, in accordance with Examples 1-20 or the other examples discussed herein.

Example 23 is a non-transitory device-readable storage medium including instructions, wherein the instructions, when executed by a processing circuitry of a device, cause the processing circuitry to perform operations for configuring or operating a floating satellite network ground station, optionally with use of adaptable feeder links, in accordance with Examples 1-20 or the other examples discussed herein.

Example 24 is an apparatus, comprising respective means for configuring or operating a floating satellite network ground station, optionally with use of adaptable feeder links, in accordance with Examples 1-20 or the other examples discussed herein.

Example 25 is a satellite vehicle comprising circuitry for configuring, communicating with, or operating a floating satellite network ground station, optionally with use of adaptable feeder links, in accordance with Examples 1-20 or the other examples discussed herein.

Example 26 is a user equipment communications device comprising circuitry for connecting with a floating satellite network ground station, optionally with use of adaptable feeder links, in accordance with Examples 1-20 or the other examples discussed herein.

Example 27 is a 5G communication network, comprising network equipment configured for connecting with a floating satellite network ground station, optionally with use of adaptable feeder links, in accordance with

Examples 1-20 or the other examples discussed herein.

Example 28 is a network comprising respective devices and device communication mediums for performing any of the operations discussed herein, in accordance with Examples 1-20 or the other examples discussed herein.

Example 29 is a system comprising respective components arranged or

configured to perform any of the operations herein, in accordance with Examples 1-20 or the other examples discussed herein.

Example 30 is a method, performed using circuitry of a computing device or other electronic component, arranged or configured to perform any of the operations discussed herein, in accordance with Examples 1-20 or the other examples discussed herein.

In the examples above, many references were provided to low-earth orbit (LEO) satellites and constellations. However, it will be understood that the examples above are also relevant to many forms of middle-earth orbit satellites and constellations, geosynchronous orbit satellites and constellations, and other high altitude communication platforms such as balloons. Thus, it will be understood that the techniques discussed for LEO network settings are also applicable to many other network settings.

Although these implementations have been described with reference to specific exemplary aspects, it will be evident that various modifications and changes may be made to these aspects without departing from the broader scope of the present disclosure. Many of the arrangements and processes described herein can be used in combination or in parallel implementations that involve terrestrial network connectivity (where available) to increase network bandwidth/throughput and to support additional edge services. Accordingly, the specification and drawings are to be regarded in an illustrative rather than a restrictive sense. The accompanying drawings that form a part hereof show, by way of illustration, and not of limitation, specific aspects in which the subject matter may be practiced. The aspects illustrated are described in sufficient detail to enable those skilled in the art to practice the teachings disclosed herein. Other aspects may be utilized and derived therefrom, such that structural and logical substitutions and changes may be made without departing from the scope of this disclosure. This Detailed Description, therefore, is not to be taken in a limiting sense, and the scope of various aspects is defined only by the appended claims, along with the full range of equivalents to which such claims are entitled.

Such aspects of the inventive subject matter may be referred to herein, individually and/or collectively, merely for convenience and without intending to voluntarily limit the scope of this application to any single aspect or inventive concept if more than one is in fact disclosed. Thus, although specific aspects have been illustrated and described herein, it should be appreciated that any arrangement calculated to achieve the same purpose may be substituted for the specific aspects shown. This disclosure is intended to cover any and all adaptations or variations of various aspects. Combinations of the above aspects and other aspects not specifically described herein will be apparent to those of skill in the art upon reviewing the above description.

What is claimed is:

1. A method of configuring a floating ground station for connectivity with a satellite non-terrestrial network (NTN), the method comprising:
receiving configuration information for a compute node to be operated as a temporary NTN ground station, the compute node located on a marine vessel capable of transiting among multiple marine locations, and the compute node having connectivity to the satellite NTN via a feeder link;
configuring the compute node to operate as the temporary NTN ground station, based on the configuration information, the temporary NTN ground station configured to process data from satellite terminals of the satellite NTN; and
modifying the feeder link to perform data communications between the temporary NTN ground station and respective orbiting satellites of the satellite NTN, the feeder link being dynamically modified based on network usage and restrictions applicable to a geographic location of the marine vessel.

2. The method of claim 1, wherein allocation of the feeder link includes respective allocations among: user plane data, control plane data, and Operations, Administration, and Maintenance (OAM) data.

3. The method of claim 2, wherein the respective allocations are adjusted based on operational conditions of the satellite NTN and data usage from one or more data networks hosted by the marine vessel.

4. The method of claim 2, wherein the respective allocations are adjusted based on one or more connection health metrics provided from among: upload block error rate, download block error rate or cyclic redundancy check (CRC) results.

5. The method of claim 1, wherein the compute node is selected to be operated as the temporary NTN ground station based on utilization metrics of one or more other NTN ground stations.

6. The method of claim 5, further comprising:
discontinuing use of the compute node as the temporary NTN ground station, based on a decrease in the utilization metrics of the one or more other NTN ground stations.

7. The method of claim 1, wherein the compute node is operated as the temporary NTN ground station when the marine vessel is undocked in a port geographic area, and wherein the temporary NTN ground station serves as a network gateway based on a wireless backhaul to an onshore network.

8. The method of claim 7, wherein the compute node is operated as the temporary NTN ground station when the marine vessel is docked in the port geographic area, and wherein the temporary NTN ground station serves as the network gateway based on a wired backhaul when the marine vessel is docked.

9. The method of claim 1, wherein the restrictions applicable to the geographic location of the marine vessel are based on an exclusion zone, wherein the exclusion zone defines one or more geographical areas of restricted wireless communications for the feeder link between the satellite NTN and the marine vessel.

10. The method of claim 9, wherein the exclusion zone defines one or more mitigations for use for transmissions from the satellite NTN, the one or more mitigations provided from among: spot beam control, frequency change, or beamsteering.

11. A device, comprising:
processing circuitry; and
at least one machine-readable medium including instructions embodied thereon, wherein the instructions, when executed by the processing circuitry, configure the processing circuitry to cause operations that:
receive configuration information for a compute node to be operated as a temporary non-terrestrial network (NTN) ground station, the compute node located on a marine vessel capable of transiting among multiple marine locations, and the compute node having connectivity to a satellite NTN via a feeder link;
configure the compute node to operate as the temporary NTN ground station, based on the configuration information, the temporary NTN ground station configured to process data from satellite terminals of the satellite NTN; and
modify the feeder link to perform data communications between the temporary NTN ground station and respective orbiting satellites of the satellite NTN, the feeder link being dynamically modified based on network usage and restrictions applicable to a geographic location of the marine vessel.

12. The device of claim 11, wherein allocation of the feeder link includes respective allocations among: user plane data, control plane data, and Operations, Administration, and Maintenance (OAM) data.

13. The device of claim 12, wherein the respective allocations are adjusted based on operational conditions of the satellite NTN and data usage from one or more data networks hosted by the marine vessel.

14. The device of claim 12, wherein the respective allocations are adjusted based on one or more connection health metrics provided from among: upload block error rate, download block error rate or cyclic redundancy check (CRC) results.

15. The device of claim 11, wherein the compute node is selected to be operated as the temporary NTN ground station based on utilization metrics of one or more other NTN ground stations.

16. The device of claim 15, wherein the instructions further configure the processing circuitry to cause operations that:
discontinue use of the compute node as the temporary NTN ground station, based on a decrease in the utilization metrics of the one or more other NTN ground stations.

17. The device of claim 11, wherein the compute node is operated as the temporary NTN ground station when the marine vessel is undocked in a port geographic area, and wherein the temporary NTN ground station serves as a network gateway based on a wireless backhaul to an onshore network.

18. The device of claim 17, wherein the compute node is operated as the temporary NTN ground station when the marine vessel is docked in the port geographic area, and wherein the temporary NTN ground station serves as the network gateway based on a wired backhaul when the marine vessel is docked.

19. The device of claim 11, wherein the restrictions applicable to the geographic location of the marine vessel are based on an exclusion zone, wherein the exclusion zone defines one or more geographical areas of restricted wireless communications for the feeder link between the satellite NTN and the marine vessel.

20. The device of claim 19, wherein the exclusion zone defines one or more mitigations for use for transmissions from the satellite NTN, the one or more mitigations provided from among: spot beam control, frequency change, or beamsteering.
